(19) United States
(12) Patent Application Publication
(10) Pub. No.: US 2015/0240086 A1
(43) Pub. Date: Aug. 27, 2015

(54) ANTI-SMUDGE BODY, DISPLAY DEVICE, INPUT DEVICE, ELECTRONIC DEVICE, AND ANTI-SMUDGE ARTICLE

(71) Applicant: DEXERIALS CORPORATION, Tokyo (JP)

(72) Inventors: Ryosuke Iwata, Utsunomiya-shi (JP); Mikihisa Mizuno, Sendai-shi (JP)

(21) Appl. No.: 14/423,566

(22) PCT Filed: Aug. 27, 2013
(86) PCT No.: PCT/JP2013/072798

§ 371 Date: Feb. 24, 2015

(30) Foreign Application Priority Data
Aug. 31, 2012 (JP) 2012-192272

(51) Int. Cl. C09D 5/16; G02B 27/00; G06F 1/16

(52) U.S. Cl. CPC C09D 5/1681; G06F 1/1643; G02B 27/0006

(57) ABSTRACT

An anti-smudge body having a surface that, when fingerprints adhere to the surface, allows the fingerprint patterns to spread spontaneously to thereby cause them to become less noticeable has the surface and a plurality of protrusions provided thereto. The protrusions contain at least one of a first compound having an ester linkage in a portion other than terminal ends and a second compound having a cyclic hydrocarbon group.

### TECHNICAL FIELD

The present technique relates to an anti-smudge body and to a display device, an input device, an electronic device, and an anti-smudge article each including the anti-smudge body. Particularly, the present technique relates to an anti-smudge body that suppresses smudges on a surface.

### BACKGROUND ART

In recent years, information display devices equipped with a touch panel as a user interface (UI) are rapidly becoming widespread. A touch panel has an advantage in that the user can operate the device intuitively by directly touching the display screen with a finger. However, a problem with the touch panel is that fingerprints adhering to the display screen deteriorate the visibility of the display screen. Therefore, there is a demand for a fingerprint resistant surface on which fingerprints adhering thereto are less noticeable.

An anti-smudge layer designed such that a fluorine-based compound or a silicon-based compound is present on the outermost surface has been used for a display surface including a touch panel (see, for example, Patent Literature 1). This is because the outermost surface of the anti-smudge layer is a water-repellent and oil-repellent surface, and has an effect in that the adhesion of oil and fat components forming fingerprints is weakened, so that the fingerprints can be easily wiped off with, for example, a cloth.

Further, a water-repellent oleophilic surface that does not repel oil and fat components has been proposed (see, for example, Patent Literature 2). When fingerprints adhere to this surface, the oil and fat components of fingerprints adhering to the surface spread and do not form droplets, so that the fingerprints are less noticeable.

### CITATION LIST

### Patent Literature

Patent Literature 1: Japanese Patent No. 4666667

Patent Literature 2: Japanese Patent Application Laid-Open No. 2010-128363

### SUMMARY OF INVENTION

### Technical Problem

As described above, there is a demand for a surface that allows fingerprints adhering thereto to become less noticeable. In consideration of applications such as capacitive type touch panels, a surface that allows fingerprint patterns to spread spontaneously to thereby cause them to become less noticeable (a fingerprint resistant surface) is considered to be important.

Accordingly, it is an object of the present technique to provide an anti-smudge body having a surface that, when fingerprints adhere to the surface, allows the fingerprint patterns to spread spontaneously to thereby cause them to become less noticeable and to provide a display device, an input device, an electronic device, and an anti-smudge article each including the anti-smudge body.

### Solution to Problem

To solve the foregoing problem, a first technique is an anti-smudge body having

a surface and a plurality of protrusions provided thereto, wherein

the protrusions contain at least one of a first compound having an ester linkage in a portion other than terminal ends and a second compound having a cyclic hydrocarbon group.

A second technique is an input device having

an input surface and a plurality of protrusions provided thereto, wherein

the protrusions contain at least one of a first compound having an ester linkage in a portion other than terminal ends and a second compound having a cyclic hydrocarbon group.

A third technique is a display device having

a display surface and a plurality of protrusions provided thereto, wherein

the protrusions contain at least one of a first compound having an ester linkage in a portion other than terminal ends and a second compound having a cyclic hydrocarbon group.

A fourth technique is an electronic device having

a surface and a plurality of protrusions provided thereto, wherein

the protrusions contain at least one of a first compound having an ester linkage in a portion other than terminal ends and a second compound having a cyclic hydrocarbon group.

A fifth technique is an anti-smudge article having

a surface and a plurality of protrusions provided thereto, wherein

the protrusions contain at least one of a first compound having an ester linkage in a portion other than terminal ends and a second compound having a cyclic hydrocarbon group.

A sixth technique is an anti-smudge body having an anti-smudge surface and a plurality of protrusions provided thereto.

In the present technique, the anti-smudge body is preferably an anti-smudge layer, an anti-smudge structure layer, or an anti-smudge substrate. The anti-smudge structure layer means a structure layer including a plurality of protrusions and an anti-smudge layer provided so as to conform to the surface of the protrusions.

In the present technique, the plurality of protrusions are disposed on the surface of the anti-smudge body, and the protrusions contain at least one of a first compound having an ester linkage in a portion other than terminal ends and a second compound having a cyclic hydrocarbon group. Therefore, when fingerprints adhere to the surface, the fingerprint patterns spread spontaneously and become less noticeable.

### Advantageous Effects of Invention

As described above, with the present technique, when fingerprints adhere to the surface of the anti-smudge body, the fingerprint patterns spread spontaneously and become less noticeable.

### BRIEF DESCRIPTION OF DRAWINGS

FIG. 1A is a cross-sectional view illustrating an example of a configuration of an anti-smudge substrate according to a first embodiment of the present technique.

FIG. 1B is a plan view illustrating the example of the configuration of the anti-smudge substrate according to the first embodiment of the present technique.

FIG. 2A is a perspective view illustrating an example of a configuration of a master roll. FIG. 2B is an enlarged plan view illustrating part of the master roll shown in FIG. 2A. FIG. 2C is a cross-sectional view in a track T in FIG. 2B.

FIG. 3 is a schematic diagram illustrating an example of a configuration of a master roll exposure apparatus for producing the master roll.

FIGS. 4A to 4C are process diagrams illustrating an example of the method of producing the anti-smudge substrate according to the first embodiment in the present technique.

FIGS. 5A and 5B are process diagrams illustrating an example of the method of producing the anti-smudge substrate according to the first embodiment in the present technique.

FIGS. 6A to 6C are process diagrams illustrating an example of the structure forming step using an energy ray curable resin or a thermosetting resin.

FIGS. 7A to 7C are process diagrams illustrating an example of the structure forming step using a thermoplastic resin composition.

FIG. 8A is a cross-sectional view illustrating an example of a configuration of an anti-smudge substrate according to a first modification. FIG. 8B is a cross-sectional view illustrating an example of a configuration of an anti-smudge substrate according to a second modification. FIG. 8C is a cross-sectional view illustrating an example of a configuration of an anti-smudge substrate according to a third modification.

FIG. 9A is a cross-sectional view illustrating an example of a configuration of an anti-smudge substrate according to a fourth modification. FIG. 9B is a cross-sectional view illustrating an example of a configuration of an anti-smudge substrate according to a fifth modification. FIG. 9C is a cross-sectional view illustrating an example of a configuration of an anti-smudge substrate according to a sixth modification.

FIG. 10 is a cross-sectional view illustrating an example of a configuration of an anti-smudge substrate according to a second embodiment of the present technique.

FIG. 11A is a cross-sectional view illustrating an example of a configuration of an anti-smudge substrate according to a third embodiment of the present technique.

FIG. 11B is an enlarged cross-sectional view representing part of FIG. 11A.

FIG. 12A is a cross-sectional view illustrating a first example of a configuration of an anti-smudge layer. FIG. 12B is a cross-sectional view illustrating a second example of a configuration of an anti-smudge layer. FIG. 12C is a cross-sectional view illustrating a third example of a configuration of an anti-smudge layer.

FIG. 13 is an exploded perspective view illustrating an example of a configuration of a display device according to a fourth embodiment of the present technique.

FIG. 14A is an exploded perspective view illustrating an example of a configuration of an input device according to a fifth embodiment of the present technique.

FIG. 14B is an exploded perspective view illustrating a modification of an input device according to the fifth embodiment of the present technique.

FIG. 15A is an external view illustrating a television set, which is an example of the electronic device.

FIG. 15B is an external view illustrating a notebook-type personal computer, which is an example of the electronic device.

FIG. 16A is an external view illustrating a cellular phone, which is an example of the electronic device. FIG. 16B is an external view illustrating a tablet-type computer, which is an example of the electronic device.

FIG. 17A is a view showing an AFM image of the surface of the anti-smudge film in Example 1. FIG. 17B is a view illustrating a cross-sectional profile along line a-a shown in FIG. 17A.

FIG. 18A is a view showing an AFM image of the surface of the anti-smudge film in Example 2. FIG. 18B is a view illustrating a cross-sectional profile along line a-a shown in FIG. 18A.

FIG. 19A is a view showing an AFM image of the surface of the anti-smudge film in Example 8. FIG. 19B is a view illustrating a cross-sectional profile along line a-a shown in FIG. 19A.

### DESCRIPTION OF EMBODIMENTS

Embodiments of the present technique will be described in the following order.

1. First embodiment (an example of an anti-smudge substrate having a fingerprint resistant surface)

2. Second embodiment (an example of an anti-smudge substrate having a fingerprint resistant surface)

3. Third embodiment (an example of an anti-smudge substrate having a fingerprint resistant surface)

4. Fourth embodiment (an example of an anti-smudge substrate having a fingerprint resistant surface)

5. Fifth embodiment (an example of a display device having a fingerprint resistant surface)

6. Sixth embodiment (an example of an input device having a fingerprint resistant surface)

7. Seventh embodiment (an example of an electronic device having a fingerprint resistant surface)

### 1. First Embodiment

### [Configuration of Anti-Smudge Substrate]

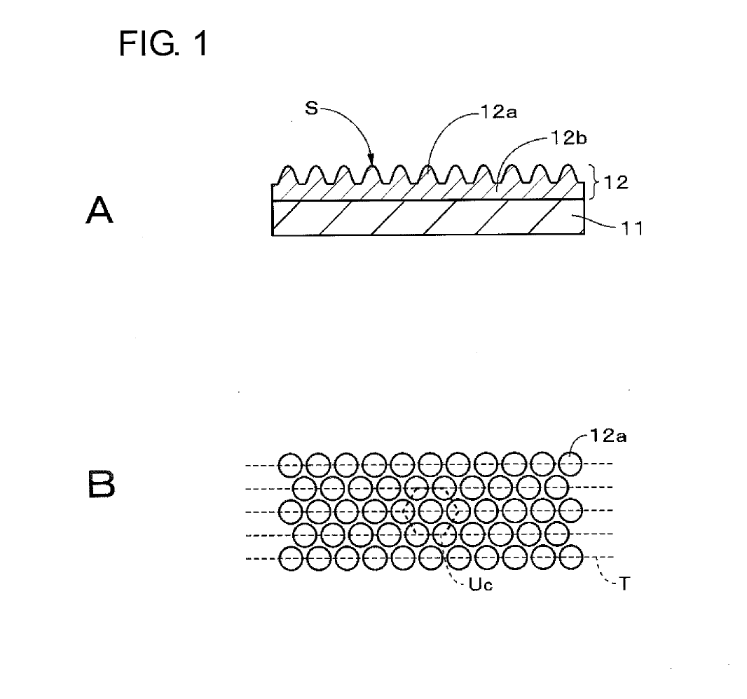

FIG. 1A is a cross-sectional view illustrating an example of a configuration of an anti-smudge substrate according to a first embodiment of the present technique. The anti-smudge substrate (anti-smudge body) has a fingerprint resistant surface (anti-smudge surface) S having an anti-fingerprint function, as shown in FIG. 1A. This fingerprint resistant surface S has fine protrusion-like structures thereon and contains a compound having a specific molecular structure described later. Therefore, fingerprints adhering to the fingerprint resistant surface S spread spontaneously and are likely to become less noticeable. When the height of the fine protrusion-like structures is set to a prescribed value, good wipeability can be obtained.

The anti-smudge substrate includes a substrate 11 and an anti-smudge layer 12 disposed on the surface of the substrate 11. In the following description, the anti-smudge substrate including the substrate 11 and the anti-smudge layer 12 will be described as an example of the anti-smudge body. However, the anti-smudge body is not limited to this example, and the anti-smudge layer 12 alone may be used as the anti-smudge body.

The anti-smudge substrate according to the first embodiment is suitably applied to the surface of a device that is touched with a hand, a finger, etc. The surface of such a device is, for example, at least one portion of a display surface, an input surface, or the surface of a casing. It is also preferable that the anti-smudge layer 12 be applied directly to the surface of the device with no substrate 11. Specific examples of the device that is touched with a hand, a finger, etc. may include display devices, input devices, and electronic devices.

Examples of the display devices may include various display devices such as a liquid crystal display, a CRT (cathode ray tube) display, a plasma display panel (PDP), an electro luminescence (EL) display, and a surface-conduction electron-emitter Display (SED).

Examples of the input devices may include, but are not limited to, touch panels, mice, and keyboards. Examples of the touch panels may include, but are not limited to, touch panels provided in television sets, personal computers, mobile devices (such as smart phones and slate PCs), and photo frames.

The electronic device is preferably an electronic device including at least one of a display device, an input device, a casing, etc. Examples of such an electronic device may include, but are not limited to, television sets, personal computers (PC), mobile devices (such as smart phones and slate PCs), and photo frames.

The objects to which the anti-smudge substrate or the anti-smudge layer 12 is applied are not limited to the above-described devices, and the anti-smudge substrate or the anti-smudge layer 12 is preferably applicable to any object having a surface touched with a hand or a finger. Examples of articles (anti-smudge articles) other than the devices described above include, but are not limited to, paper, plastic, glass, and metal products (specifically, for example, photographs, photograph stands, plastic cases, metal cases, glass windows, plastic windows, picture frames, lenses, furniture, and electric appliances).

### (Substrate)

The substrate 11 is, for example, a transparent inorganic substrate or a transparent plastic substrate. The shape of the substrate 11 used may be, for example, a film shape, a sheet shape, plate shape, or a block shape. Examples of the material of the inorganic substrate may include quartz, sapphire, and glass. Any known macromolecular material can be used as the material of the plastic substrate. Specific examples of the known macromolecular material may include triacetylcellulose (TAC), polyester (TPEE), polyethylene terephthalate (PET), polyethylene naphthalate (PEN), polyimide (PI), polyamide (PA), aramid, polyethylene (PE), polyacrylate, polyether sulfone, polysulfone, polypropylene (PP), polystyrene, diacetylcellulose, polyvinyl chloride, acrylic resin (PMMA), polycarbonate (PC), epoxy resin, urea resin, urethane resin, melamine resin, phenol resin, acrylonitrile-butadiene-styrene copolymers, cycloolefin polymers (COP), cycloolefin copolymers (COC), PC/PMMA stacked body, and rubber added PMMA. A design or a pattern may be printed or vapor-deposited on the substrate. When the anti-smudge substrate is used for an exterior application, the substrate 11 may not be transparent. Examples of the material of the substrate 11 may include stainless steel, magnesium alloys, aluminum, aluminum alloys, titanium alloys, galvalume steel, and carbon fiber reinforced plastics.

The substrate 11 may be processed into part of the exterior or display of an electronic device etc. The surface shape of the substrate 11 is not limited to a flat shape, and the substrate 11 may have an uneven surface, a polygonal surface, a curved surface, or a combination thereof. Examples of the curved surface may include a spherical surface, an elliptic surface, a parabolic surface, and a free curved surface. The anti-smudge substrate may be formed into the curved surface by, for example, an in-mold molding process. The in-mold molding is a process in which the anti-smudge substrate is placed in a mold and a resin such as a plastic is injected to perform molding and surface decorating simultaneously. Alternatively, the anti-smudge substrate itself may be subjected to press working using a pressing die to form the anti-smudge substrate into the above-described curved surface. In any of the above molding processes, a protective film may be placed on the anti-smudge layer of the anti-smudge substrate, in order to protect the protrusions on the surface of the anti-smudge substrate from being damaged. A prescribed structure may be provided on the surface of the substrate 11 by, for example, UV transfer, thermal transfer, pressure transfer, melt extrusion, etc.

### (Anti-Smudge Layer)

The anti-smudge layer 12 includes a plurality of protrusions 12a on the fingerprint resistant surface S. The anti-smudge layer 12 may further include a base layer 12b between the substrate 11 and the plurality of protrusions 12a. The base layer 12b is a layer formed integrally with the protrusions 12a on the bottom side of the protrusions 12a and is formed from the same material as that of the protrusions 12a. The anti-smudge layer 12 is a modified surface layer containing at least one of a first compound having an ester linkage in a portion other than its terminal ends and a second compound having a cyclic hydrocarbon group. Since the anti-smudge layer 12 contains at least one of the first compound and the second compound, the ease of wiping off fingerprints can be improved. The above terminal ends are terminal ends of the main and side chains. The anti-smudge layer 12 is a coating layer formed by, for example, a wet process or a dry process.

When the anti-smudge layer 12 contains the second compound, it is preferable that the anti-smudge layer 12 further contain, together with the second compound, a third compound having a chain hydrocarbon group at its terminal end. In this case, the ease of wiping off fingerprints can be further improved. The above terminal end is a terminal end of any of the main and side chains. No particular limitation is imposed on the contents of the second and third compounds in the anti-smudge layer 12. However, since the third compound has the property of gathering on the fingerprint resistant surface S relatively easily, it is preferable that the contents be selected in consideration of this property.

The anti-smudge layer 12 contains at least one selected from the group consisting of energy ray-curable resin compositions, thermosetting resin compositions, and thermoplastic resin compositions. These resin compositions contain, for example, at least one of the first compound and the second compound. When these resin compositions contain the second compound, it is preferable that they contain the third compound together with the second compound.

If necessary, the anti-smudge layer 12 may further contain additives such as a polymerization initiator, a light stabilizer, an ultraviolet absorber, a catalyst, a coloring agent, an antistatic agent, a lubricant, a leveling agent, an antifoaming agent, a polymerization promoter, an antioxidant, a flame retardant, an infrared absorber, a surfactant, a surface modifier, a thixotropic agent, and a plasticizer. The anti-smudge layer 12 may further contain light-scattering particles such as an organic resin filler that scatter light, in order to impart an AG (Anti-Glare) function to the fingerprint resistant surface S. When the AG function is imparted, the light-scattering particles may protrude from the fingerprint resistant surface S of the anti-smudge layer 12 or may be covered with, for example, a resin contained in the anti-smudge layer 12. The light-scattering particles may or may not be in contact with the substrate 11, which is a lower layer. The average thickness of the anti-smudge layer 12 is within the range of, for example, a monomolecular thickness or more and 1 mm or less, preferably a monomolecular thickness or more and 100 μm or less, and particularly preferably a monomolecular thickness or more and 10 μm or less.

The first compound and/or the second compound is, for example, at least one of main and accessory components of the material constituting the anti-smudge layer 12. When the anti-smudge layer 12 is a layer formed by a wet process, the main component is, for example, a base resin, and the accessory component is, for example, an additive such as the leveling agent described above. Preferably, the first, second and third compounds are additives. This is because, for example, deterioration of hardness of the base resin can be suppressed. When any of these compounds is an additive as described above, it is preferable that the additive be a leveling agent. When the first, second and third compounds are additives such as a leveling agent, it is preferable that the first, second, and third compounds be bonded to the base resin through, for example, a polymerization reaction. This is because the durability of the fingerprint resistant surface S can be improved.

### (Protrusions)

FIG. 1B is a plan view illustrating an example of an arrangement of the plurality of protrusions disposed on the surface of the substrate 11. As shown in FIG. 1B, the plurality of protrusions 12a are arranged two-dimensionally on the surface of the substrate 11. The arrangement may be any of a regular arrangement and a random arrangement. However, when the anti-smudge substrate is produced using a production method described later, a regular arrangement is preferred.

The plurality of protrusions 12a have an arrangement pattern in which a plurality of tracks T are formed on the surface of the substrate 11. In the present technique, the tracks are rows of protrusions 12a. The tracks T may have a linear shape, a circular shape, or an arc shape, and the tracks T having any of these shapes may be wobbled (meandered). Such wobbled tracks T can suppress the occurrence of unevenness in appearance.

When the tracks T are wobbled, it is preferable that the wobbles of the respective tracks T on the substrate 11 be synchronized. Specifically, it is preferable that the wobbles are synchronized wobbles. By synchronizing the wobbles, the shape of unit cells Uc can be maintained, and a high filling factor can be maintained. Examples of the waveform of the wobbled tracks T may include sinusoidal waves and triangular shapes. The waveform of the wobbled tracks T is not limited to a periodic waveform, and the wobbled tracks T may have an aperiodic waveform. The amplitude of the wobbles of the wobbled tracks T is selected to be, for example, about ±10 nm.

The plurality of protrusions 12a arranged so as to form the plurality of tracks T may form a regular periodic pattern. From the viewpoint of improving the filling factor, it is preferable that the plurality of protrusions 12a be arranged in a closest packed structure with a regular periodic pattern. The regular periodic pattern used may be a pattern including unit cells Uc. Examples of the unit cells Uc may include lattice patterns such as quadrilateral lattice patterns and hexagonal lattice patterns, and these lattice patterns may be distorted. The height of the protrusions 12a may be regularly or irregularly changed on the surface of the substrate 11.

Examples of the shape of the protrusions 12a may include cone shapes, columnar shapes, needle-like shapes, shapes formed of part of a sphere (for example, hemispherical shapes), shapes formed of part of an ellipsoid (for example, hemiellipsoidal shapes), and polygonal shapes. However, the shape of the protrusions 12a is not limited to these shapes, and any other shape may be used. Examples of the cone shapes may include, but are not limited to, cone shapes with sharp apexes, cone shapes with flat apexes (truncated cone shapes), and cone shapes with convex or concave curved surfaces at their apexes. Examples of the cone shapes with sharp apexes may include a circular cone and polygonal pyramids. Examples of the polygonal pyramids may include a triangular pyramid, a quadrangular pyramid, a pentagonal pyramid, a hexagonal pyramid, and other pyramids. Examples of the cone shapes with flat apexes (truncated cone shapes) may include truncated circular cones and truncated polygonal pyramids. Examples of the truncated polygonal pyramids may include a truncated triangular pyramid, a truncated quadrangular pyramid, a truncated pentagonal pyramid, a truncated hexagonal pyramid, and other truncated pyramids. Examples of the cone shapes with convex curved at their apexes may include quadric surfaces such as: a cone shape in which its gradient is small at the apex and increases gradually from the central portion toward the bottom (a cone shape with a paraboloidal surface); and a cone shape in which its gradient at the central portion is larger than that at the bottom and the apex. The cone surface of a cone may be curved convexly or concavely. Examples of the columnar shapes may include cylinders and polygonal columns. Examples of the polygonal columns may include quadrangular columns, pentagonal columns, hexagonal columns, and other polygonal columns.

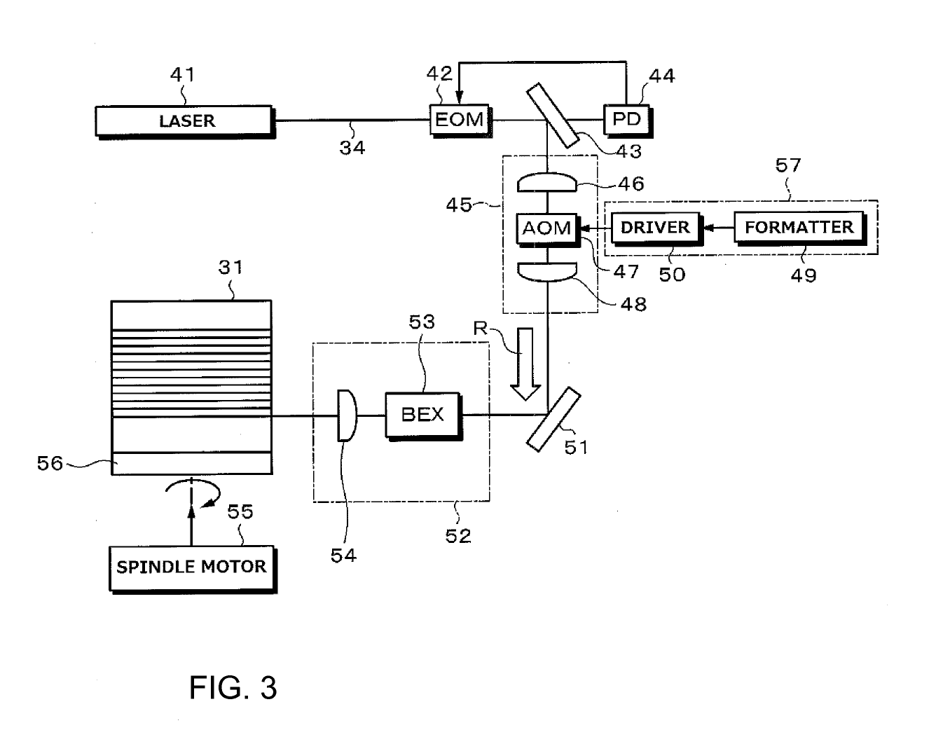

When a master roll is produced using a master roll exposure apparatus (see FIG. 3) described later, it is preferable that the shape of the protrusions 12a be an elliptic cone shape with a convex curved surface at the apex or an elliptic cone shape with a flat apex and that the major axis direction of the ellipse forming their bottom surface coincide with the extending direction of the tracks T. The circular, elliptic, circular cone, elliptic cone, spherical, ellipsoidal, and parabolic shapes are meant to include not only mathematically defined perfect circular, elliptic, circular cone, elliptic cone, spherical, ellipsoidal, and parabolic shapes but also somewhat distorted circular, elliptic, circular cone, elliptic cone, spherical, ellipsoidal, and parabolic shapes.

In FIGS. 1A and 1B, the protrusions 12a have the same size, shape, arrangement pitch, height, and aspect ratio. However, the configuration of the protrusions 12a is not limited thereto, and protrusions 12a with at least two different sizes, shapes, arrangement pitches, heights, and aspect ratios may be provided on the surface of the substrate. The aspect ratio of a protrusion 12a means the ratio of the height of the protrusion 12a to its arrangement pitch P (H/P). The arrangement pitches P of protrusions 12a, their heights H and/or their aspect ratios (H/P) may be different in different in-plane directions on the surface of the substrate. No particular limitation is imposed on the positional relation between adjacent protrusions 12a, and adjacent protrusions 12a may be configured so as to be spaced apart from each other, be in contact with each other, or partially overlap each other.

The protrusions 12a may be formed so as to have a prescribed height distribution. The height distribution means that protrusions 12a with at least two different heights are provided on the surface of the substrate 11. For example, protrusions 12a having a reference height and protrusions 12a having a height different from the height of the above protrusions 12a may be provided on the surface of the substrate 11. In this case, the protrusions 12a having a height different from the reference height may be, for example, disposed periodically or aperiodically (randomly) on the surface of the substrate 11. The direction of the periodicity may be, for example, the extending direction of the tracks T or a direction at a prescribed angle from the tracks T (an inter-track direction).

The average arrangement pitch Pm of the protrusions 12a is preferably in the range of 1 nm or larger and 1 mm or smaller, more preferably in the range of 10 nm or larger and 1 μm or smaller, and still more preferably in the range of 100 nm or larger and 500 nm or smaller. When the average arrangement pitch Pm is 1 nm or larger and 1 mm or smaller, fingerprint patterns spread effectively. The pitches of the protrusions 12a may not be uniform.

The average height H of the protrusions 12a is preferably in the range of 1 nm or larger and 1 mm or smaller, more preferably in the range of 5 nm or larger and 300 nm or smaller, still more preferably in the range of 10 nm or larger and 150 nm or smaller, and most preferably in the range of 10 nm or larger and 100 nm or smaller. When the average height H is 1 nm or larger and 1 mm or smaller, fingerprint patterns spread effectively. When the average height H is 100 nm or smaller, fingerprints adhering to the fingerprint resistant surface S of the anti-smudge substrate can be made less noticeable by rubbing the fingerprints with, for example, a finger to spread them thinly. Therefore, the ease of wiping off fingerprints with a finger etc. can be improved. The heights of the protrusions 12a may not be uniform.

The average aspect ratio (the average height Hm/the average arrangement pitch Pm) of the protrusions 12a is preferably in the range of 0.000001 or larger and 1,000,000 or smaller, more preferably in the range of 0.005 or larger and 300 or smaller, and still more preferably in the range of 0.02 or larger and 1 or smaller. When the average aspect ratio (the average height Hm/the average arrangement pitch Pm) is 0.000001 or larger and 1,000,000 or smaller, fingerprint patterns spread effectively.

The average arrangement pitch Pm, average height Hm, and average aspect ratio (Hm/Pm) of the protrusions 12a are determined as follows.

First, the fingerprint resistant surface S having the protrusions 12a is observed under an atomic force microscope (AFM), and pitches and heights of protrusions 12a are determined from an AFM cross sectional profile. This procedure is repeated for 10 regions randomly selected on the fingerprint resistant surface S to determine arrangement pitches P1, P2, . . . , P10 and heights H1, H2, . . . , H10. The pitch of protrusions 12a is the distance between the apexes of these protrusions 12a, and the heights of the protrusions 12a are their heights with reference to the lowest point in recessed portions (valley portions) between the protrusions. Then the pitches P1, P2, . . . , P10 and the heights H1, H2, . . . , H10 are simply averaged (arithmetically averaged) to determine the average arrangement pitch Pm and average height Hm of the protrusions 12a. Next, the average aspect ratio Hm/Pm is determined from the determined average arrangement pitch Pm and average height Hm. When the pitches of the protrusions 12a are in-plane anisotropic, the average arrangement pitch Pm is determined using arrangement pitches in a direction in which the arrangement pitches are maximum. When the heights of the protrusions 12a are in-plane anisotropic, the average height Hm is determined using heights in a direction in which the heights are maximum.

The reflectance (5° reflectance) of the anti-smudge substrate on the fingerprint resistant surface S side is preferably in the range of 1% or higher and 10% or lower. When the reflectance is 1% or higher, fingerprint patterns are less noticeable in fingerprint-adhering regions and non-adhering regions.

The reflectance is determined as follows.

First, treatment for cutting reflection from the rear surface of the anti-smudge substrate (the surface opposite to the side on which the protrusions 12a are formed) is performed by applying a black tape to the rear surface of the anti-smudge substrate. Next, the reflectance is measured using an ultraviolet and visible spectrophotometer (product name: V-500, manufactured by JASCO Corporation). For the measurement, a regular reflection 5° unit is used. The above reflectance is a reflectance at a wavelength of 550 nm.

When liquid is present on the fingerprint resistant surface S, it is preferable that the recessed portions between the protrusions 12a cause positive capillary pressure to act on the liquid. When positive capillary pressure acts on a liquid droplet present on the fingerprint resistant surface S, the liquid droplet can be allowed to spread thinly. It is preferable to allow capillary pressure in a depth direction to act on the liquid droplet in addition to the positive capillary pressure. This is because the liquid droplet can be allowed to spread more thinly. Capillary pressure acting in a direction away from the liquid droplet on the fingerprint resistant surface S is defined as the positive capillary pressure.

### (First Compound)

The first compound may be an organic material, an organic-inorganic composite material, a macromolecular material, or a monomolecular material, so long as the first compound has an ester linkage in a portion other than terminal ends. No particular limitation is imposed on the molecular structure of the first compound so long as it has an ester linkage, and the first compound may have any functional group, any bonding site, any hetero atom, any halogen atom, any metal atom, etc. The first compound used may be, for example, a compound having, in its molecule, a structure represented by the formula (1) or (2) below.

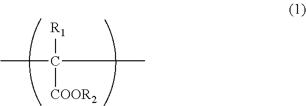

In the formula (1), R₁ is a group containing an atom such as C, N, S, O, Si, P, or Ti. The group containing such an atom is, for example, a hydrocarbon group, a sulfo group (including a sulfonate), a sulfonyl group, a sulfonamide group, a carboxylic acid group (including a carboxylate), an amino group, an amide group, a phosphoric acid group (including a phosphate and a phosphoric ester), a phosphino group, a silanol group, an epoxy group, an isocyanate group, a cyano group, a thiol group, or a hydroxyl group. R₂ is a group having at least 2 carbon atoms and is, for example, a group containing an atom such as C, N, S, O, Si, P, or Ti. The group containing such an atom is, for example, a hydrocarbon group, a sulfo group (including a sulfonate), a sulfonyl group, a sulfonamide group, a carboxylic acid group (including a carboxylate), an amino group, an amide group, a phosphoric acid group (including a phosphate and a phosphoric ester), a phosphino group, a silanol group, an epoxy group, an isocyanate group, a cyano group, a thiol group, or a hydroxyl group.

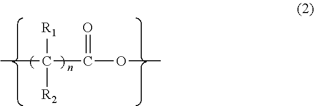

In the formula (2), R₁ and R₂ are each independently a group containing an atom such as C, N, S, O, Si, P, or Ti. The group containing such an atom is, for example, a hydrocarbon group, a sulfa group (including a sulfonate), a sulfonyl group, a sulfonamide group, a carboxylic acid group (including a carboxylate), an amino group, an amide group, a phosphoric acid group (including a phosphate and a phosphoric ester), a phosphino group, a silanol group, an epoxy group, an isocyanate group, a cyano group, a thiol group, or a hydroxyl group.

### (Second Compound)

The second compound has a cyclic hydrocarbon group. The cyclic hydrocarbon group may be, for example, an unsaturated cyclic hydrocarbon group or a saturated cyclic hydrocarbon group and may have, in its molecule, both an unsaturated cyclic hydrocarbon group and a saturated cyclic hydrocarbon group. The anti-smudge layer 12 may contain both a second compound having an unsaturated cyclic hydrocarbon group and a second compound having a saturated cyclic hydrocarbon group. The cyclic hydrocarbon group may be any of a monocyclic hydrocarbon group and a polycyclic hydrocarbon group. The cyclic hydrocarbon group may have an additional substituent. Examples of the additional substituent may include a hydrocarbon group, a sulfo group (including sulfonates), a sulfonyl group, a sulfonamide group, a carboxylic acid group (including carboxylates), an amino group, an amide group, a phosphoric acid group (including phosphates and phosphoric esters), a phosphino group, a silanol group, an epoxy group, an isocyanate group, a cyano group, a thiol group, and a hydroxyl group. The second compound may be an organic material, an organic-inorganic composite material, a macromolecular material, or a monomolecular material, so long as the second compound has a cyclic hydrocarbon group. No particular limitation is imposed on the molecular structure of the second compound so long as it has a cyclic hydrocarbon group, and the second compound may have any functional group, any bonding site, any hetero atom, any halogen atom, any metal atom, etc. Examples of the saturated cyclic hydrocarbon group may include groups having 5 or more carbon atoms and having monocyclo, bicyclo, tricyclo, and tetracyclo structures and similar structures. More specific examples thereof may include a cyclopentyl group, a cyclohexyl group, a cycloheptyl group, a cyclooctyl group, a cyclononyl group, a cyclodecyl group, a cyclododecyl group, an adamantyl group, a noradamantyl group, a tricyclodecyl group, a tetracyclododecyl group, a norbornyl group, an isobornyl group, and a steroid group. Examples of the unsaturated cyclic hydrocarbon group may include a phenyl group, a naphthyl group, a pyrenyl group, a pentacenyl group, and an anthryl group.

For example, a compound having, in its molecule, a structure represented by the formula (3) below may be used as the organic material.

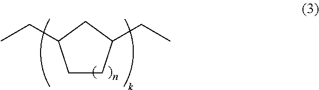

For example, a compound having, in its molecule, a structure represented by the formula (4) below may be used as the organic-inorganic composite material.

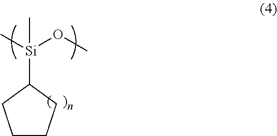

### (Third Compound)

The third compound has a chain hydrocarbon group (an acyclic hydrocarbon group) at its terminal end. The chain hydrocarbon group is, for example, any of an unsaturated chain hydrocarbon group and a saturated chain hydrocarbon group, and the third compound may contain, in its molecule, both an unsaturated chain hydrocarbon group and a saturated chain hydrocarbon group. The chain hydrocarbon group may be a linear chain hydrocarbon group or a branched chain hydrocarbon group, and the third compound may contain, in its molecule, both a linear chain hydrocarbon group and a branched chain hydrocarbon group. The chain hydrocarbon group may have an additional substituent. Examples of the additional substituent may include a hydrocarbon group, a sulfo group (including sultanates), a sulfonyl group, a sulfonamide group, a carboxylic acid group (including a carboxylate), an amino group, an amide group, a phosphoric acid group (including phosphates and phosphoric esters), a phosphino group, a silanol group, an epoxy group, an isocyanate group, a cyano group, a thiol group, and a hydroxyl group.

Any of an organic material, an organic-inorganic composite material, a macromolecular material, and a monomolecular material may be used as the third compound, so long as it is a compound having a chain hydrocarbon group at its terminal end. No particular limitation is imposed on the molecular structure of the third compound so long as it has a chain hydrocarbon group at its terminal end, and the third compound may have any functional group, any bonding site, any hetero atom, any halogen atom, any metal atom, etc. Examples of the unsaturated chain hydrocarbon group may include unsaturated chain hydrocarbon groups having at least 2 carbon atoms. Specific examples thereof may include a propene group, a butene group, a pentene group, a hexene group, a heptene group, an octene group, a decene group, a dodecene group, a tetradecane group, a hexadecene group, an octadecene group, and a docosene group. Examples of the saturated chain hydrocarbon group may include saturated chain hydrocarbon groups having at least 2 carbon atoms. More specific examples thereof may include an ethyl group, a propyl group, an isopropyl group, a butyl group, an isobutyl group, a pentyl group, an isopentyl group, a hexyl group, an isohexyl group, a heptyl group, an isoheptyl group, an octyl group, an isooctyl group, a nonyl group, an isononyl group, a decyl group, an isodecyl group, a dodecyl group, an isododecyl group, a lauryl group, a tridecyl group, an isotridecyl group, a myristyl group, an isomyristyl group, a cetyl group, an isocetyl group, a stearyl group, an isostearyl group, an arachidyl group, an isoarachidyl group, a behenyl group, an isobehenyl group, and a cholesterol group.

For example, a compound having, in its molecule, a structure represented by the formula (5) below may be used as the organic material.

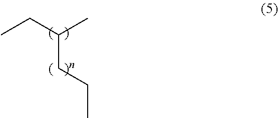

For example, a compound having, in its molecule, a structure represented by the formula (6) below may be used as the organic-inorganic composite material.

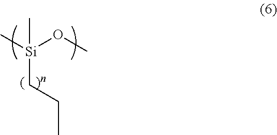

### (Method of Examining Fingerprint Resistant Surface)

Whether or not the anti-smudge substrate has a fingerprint resistant surface S can be examined, for example, as follows. First, dynamic contact angles on the surface of the anti-smudge substrate are measured to examine whether or not the advancing contact angle of oleic acid is in the range of 15° or less and the receding contact angle of oleic acid is in the range of 10° or less. Then, when the advancing contact angle of oleic acid and the receding contact angle of oleic acid are within the above ranges, it can be judged that the anti-smudge substrate has a fingerprint resistant surface S. The surface shape of the fingerprint resistant surface S can be examined by surface observation under a scanning electron microscope or an atomic force microscope.

The following examination is also possible.

First, the material of the surface of the anti-smudge substrate is extracted with a solvent and subjected to composition analysis by Gas Chromatograph-Mass Spectrometry (GC-MASS). When at least one of the first and second compounds described above is detected, it can be judged that the anti-smudge substrate has a fingerprint resistant surface S.

A combination of the two examination methods described above may be used to examine whether or not the anti-smudge substrate has a fingerprint resistant surface S.

### [Configuration of Master]

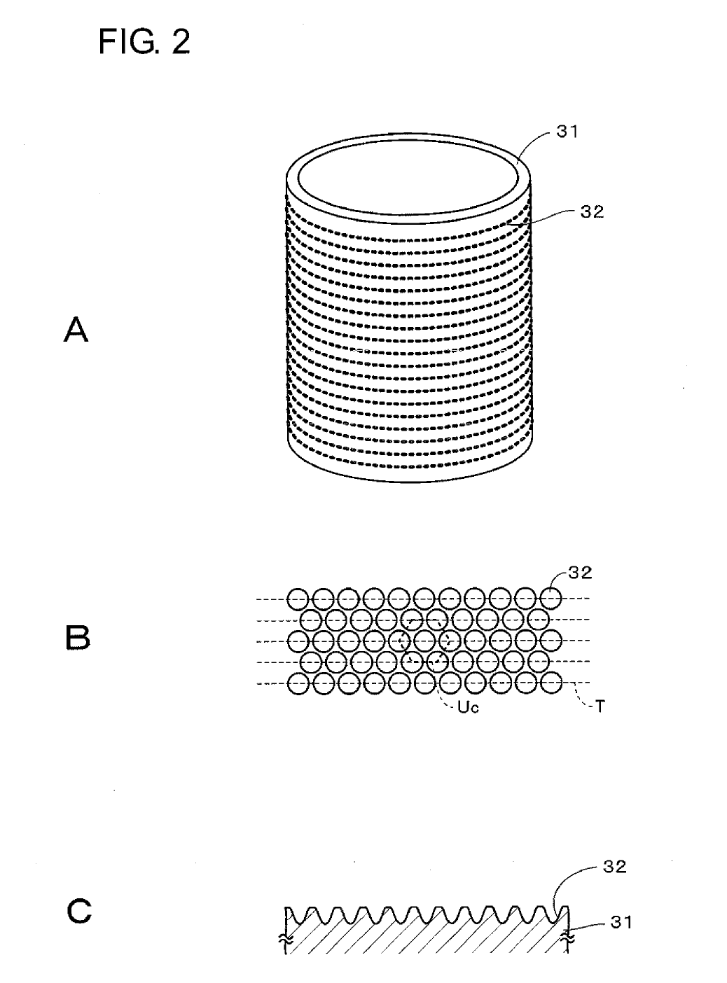

FIG. 2A is a perspective view illustrating an example of a configuration of a master roll. FIG. 2B is an enlarged plan view illustrating part of the master roll shown in FIG. 2A. FIG. 2C is a cross-sectional view in a track T in FIG. 2B. The master roll 31 is a master for producing an anti-smudge substrate having the configuration described above and more specifically is a master for molding a plurality of protrusions 12a on the surface of the substrate described above. The master roll 31 has, for example, a circular columnar or tubular shape, and the circular columnar or tubular surface is a molding surface for molding a plurality of protrusions 12a on the surface of the substrate. A plurality of structures 32, for example, are arranged two-dimensionally on the molding surface. The structures 32 are recessed from the molding surface. The material used for the master roll 31 can be, for example, glass, but the material is not particularly limited thereto.

The plurality of structures 32 arranged on the molding surface of the master roll 31 and the plurality of protrusions 12a arranged on the surface of the substrate 11 described above have an inverted concave-convex relationship with each other. In other words, the arrangement, size, shape, arrangement pitch, height, aspect ratio, etc. of the structures 32 of the master roll 31 are the same as those of the protrusions 12a of the substrate 11.

### [Configuration of Exposure Apparatus]

FIG. 3 is a schematic diagram illustrating an exemplary configuration of a master roll exposure apparatus for producing the master roll. This master roll exposure apparatus is configured on the basis of an optical disc recording apparatus.

A laser light source 41 is a light source for light exposure of a layer of a resist formed on the surface of the master roll 31 used as a recording medium and emits, for example, recording laser light 34 having a wavelength λ=266 nm. The laser light 34 emitted from the laser light source 41 travels in a straight line as a collimated beam and is incident on an electro optical modulator (EOM) 42. The laser light 34 passing through the electro optical modulator 42 is reflected from a mirror 43 and guided to a modulation optical system 45.

The mirror 43 includes a polarization beam splitter and has the function of reflecting one of polarized components and allowing the other polarized component to pass therethrough. The polarized component passing through the mirror 43 is received by a photodiode 44, and the electro optical modulator 42 is controlled on the basis of the received light signal to perform phase modulation of the laser light 34.

In the modulation optical system 45, the laser light 34 is focused on an acousto-optic modulator (AOM) 47 formed of glass (SiO₂) etc. through a condenser lens 46. The laser light 34 is subjected to intensity modulation through the acousto-optic modulator 47, diverged, and then converted to a collimated beam through a lens 48. The laser light 34 emitted from the modulation optical system 45 is reflected from a mirror 51 and guided to a movable optical table 52 horizontally and parallel.

The movable optical table 52 includes a beam expander 53 and an objective lens 54. The laser light 34 guided to the movable optical table 52 is shaped into a desired beam shape by the beam expander 53 and then directed onto a resist layer on the master roll 31 through the objective lens 54. The master roll 31 is placed on a turntable 56 connected to a spindle motor 55. The step of exposing the resist layer to light is performed by rotating the master roll 31 and irradiating the resist layer intermittently with the laser light 34 while the laser light 34 is moved in a direction of the height of the master roll 31. Latent images formed have a substantially elliptic shape with a major axis extending in a circumferential direction. The laser light 34 is moved by moving the movable optical table 52 in the direction of an arrow R.

The exposure apparatus includes a control mechanism 57 for forming, on the resist layer, latent images corresponding to the two-dimensional pattern of the plurality of protrusions 12a described above. The control mechanism 57 includes a formatter 49 and a driver 50. The formatter 49 includes a polarity inversion unit, and the polarity inversion unit controls the timing of irradiation of the resist layer with the laser light 34. The driver 50 controls the acousto-optic modulator 47 in response to the output from the polarity inversion unit.

In this master roll exposure apparatus, a polarity inversion formatter signal is synchronized with a rotation controller to generate a signal for each track such that the two-dimensional pattern is spatially linked, and intensity modulation is performed by the acousto-optic modulator 47. By performing patterning at a constant angular velocity (CAV), an appropriate number of revolutions, an appropriate modulation frequency, and an appropriate feed pitch, a two-dimensional pattern such as a hexagonal lattice pattern can be recorded.

### [Method of Producing Anti-Smudge Substrate]

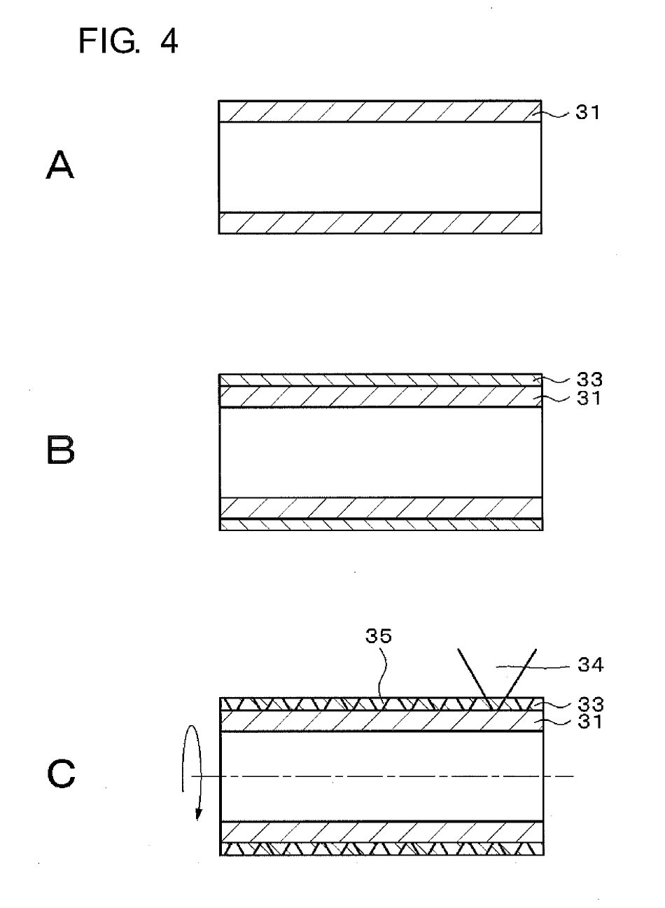

FIGS. 4A to 7C are process diagrams illustrating an example of the method of producing the anti-smudge substrate according to the first embodiment in the present technique.

### (Resist Layer Forming Step)

First, as shown in FIG. 4A, a circular columnar or tubular master roll 31 is prepared. The master roll 31 is, for example, a glass master. Next, as shown in FIG. 4B, a resist layer 33 is formed on the surface of the master roll 31. The material used for the resist layer 33 may be, for example, any of organic resists and inorganic resists. For example, a novolac-based resist or a chemically-amplified resist may be used as the organic resist. For example, a metal compound may be used as the inorganic resist.

### (Exposure Step)

Next, as shown in FIG. 4C, the resist layer 33 formed on the surface of the master roll 31 is irradiated with the laser light (exposure beam) 34. Specifically, the master roll 31 is placed on the turntable 56 of the master roll exposure apparatus shown in FIG. 3. Then, while the master roll 31 is rotated, the resist layer 33 is irradiated with the laser light (exposure beam) 34. In this case, the resist layer 33 is intermittently irradiated with the laser light 34 while the laser light 34 is moved in the height direction of the master roll 31 (a direction parallel to the center axis of the circular columnar or tubular master roll 31), whereby the entire surface of the resist layer 33 is exposed to the light. In this manner, latent images 35 corresponding to the trajectory of the laser light 34 are formed over the entire surface of the resist layer 33.

For example, the latent images 35 are arranged on the surface of the master roll so as to form a plurality of tracks and are formed into a regular periodic pattern with prescribed unit cells Uc. The latent images 35 have, for example, a circular or elliptic shape. When the latent images 35 have an elliptic shape, it is preferable that the elliptic shape have a major axis direction in the extending direction of the tracks T.

### (Development Step)

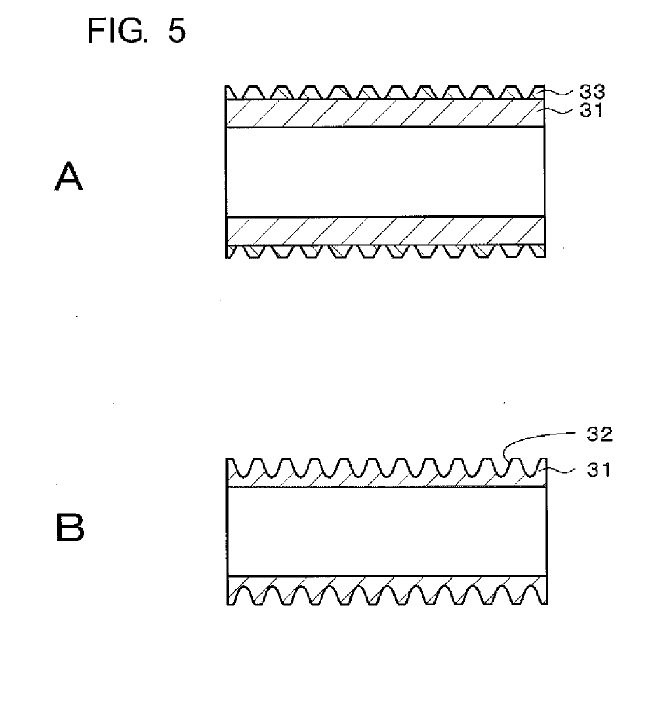

Next, for example, a developer is dropped onto the resist layer 33 while the master roll 31 is rotated to thereby subject the resist layer 33 to development treatment. In this manner, a plurality of openings are formed in the resist layer 33, as shown in FIG. 5A. When a positive resist is used to form the resist layer 33, exposed portions exposed to the laser light 34 have a higher rate of dissolution in the developer than non-exposed portions, and therefore a pattern corresponding to the latent images (exposed portions) is formed in the resist layer 33, as shown in FIG. 5A. The pattern of the openings is, for example, a regular periodic pattern with prescribed unit cells Uc.

### (Etching Step)

Next, the surface of the master roll 31 is etched using, as a mask, the pattern of the resist layer 33 (resist pattern) formed on the master roll 31. In this manner, structures (recessed portions) 32 having a cone shape can be obtained, as shown in FIG. 5B. Preferably, the cone shape is, for example, an elliptic cone or truncated elliptic cone shape with its major axis direction in the extending direction of the tracks T. For example, the etching used may be dry etching or wet etching. In this case, by performing etching treatment and ashing treatment alternately, a pattern of cone-shaped structures 32, for example, can be formed. The intended master roll 31 can thereby be obtained.

### (Structure Forming Step)

Next, the master roll 31 obtained as described above is used to perform shape transfer onto a resin material. A plurality of protrusions 12a are thereby formed on the surface of the substrate 11, whereby the above-described anti-smudge substrate according to the first embodiment is produced. The shape transfer method used may be, for example, a transfer method using an energy ray-curable resin (hereinafter referred to as an “energy ray transfer method”), a transfer method using a thermosetting resin (hereinafter referred to as a “thermosetting transfer method”), or a transfer method using a thermoplastic resin composition (hereinafter referred to as a “thermal transfer method”). The energy ray transfer method is meant to include a 2P transfer method (Photo Polymerization: a shape imparting method using photo-curing). Hereinafter, the structure forming step will be described for two different cases, i.e., a structure forming step using the energy ray transfer method or the thermosetting transfer method and a structure forming step using the thermal transfer method.

### [Structure Forming Step Using Energy Ray Transfer Method or Thermosetting Transfer Method]

### (Step of Preparing Resin Composition)

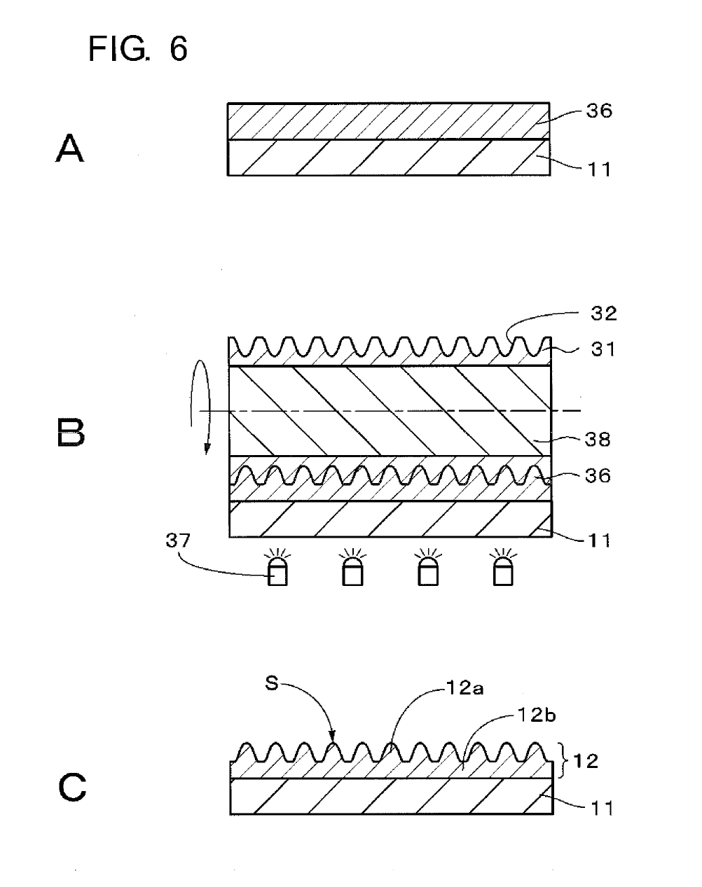

FIGS. 6A to 6C are process diagrams illustrating an example of the structure forming step using the energy ray transfer method or the thermosetting transfer method. First, if necessary, a resin composition is dissolved in a solvent to dilute the resin composition. In this case, various additives may be added to the resin composition as needed. The dilution with the solvent is performed optionally. When no dilution is necessary, the resin composition may be used without any solvent.

The resin composition contains at least one of an energy ray-curable resin composition and a thermosetting resin composition. The energy ray-curable resin composition means a resin composition that can be cured by irradiation with energy rays. The energy rays are those that can trigger a polymerization reaction of radicals, cations, anions etc. and are energy rays such as an electron beam, ultraviolet rays, infrared rays, a laser beam, visible light, ionizing radiation (X-rays, α-rays, β-rays, γ-rays etc.), microwaves, or high-frequency waves. If necessary, the energy ray-curable resin composition used may be mixed with another resin composition and, for example, may be mixed with another curable resin composition such as a thermosetting resin composition. The energy ray-curable resin composition may be an organic-inorganic hybrid material. A mixture of two or more types of energy ray-curable resin compositions may be used. Preferably, the energy ray-curable resin composition used is an ultraviolet ray-curable resin composition that is cured by irradiation with ultraviolet rays.

The energy ray-curable resin composition and the thermosetting resin contain, for example, at least one of the first compound having an ester linkage in a portion other than terminal ends and the second compound having a cyclic hydrocarbon group. Preferably, from the viewpoint of improving the ease of wiping off fingerprints, the energy ray-curable resin composition and/or the thermosetting resin further contain the third compound having a chain hydrocarbon group at its terminal end in addition to the second compound.

When the resin composition further contains an additive (including an initiator) in addition to a base resin, the first, second, and third compounds may be additives. In this case, the additive is preferably a leveling agent.

The ultraviolet ray-curable resin composition contains, for example, an initiator and a (meth)acrylate having a (meth)acryloyl group. The (meth)acryloyl group means an acryloyl group or a methacryloyl group. The (meth)acrylate means an acrylate or a methacrylate. The ultraviolet ray-curable resin composition contains, for example, a monofunctional monomer, a bifunctional monomer, a polyfunctional monomer, etc. More specifically, the ultraviolet ray-curable resin composition is one of the materials shown below or a mixture of two or more thereof.

Examples of the monofunctional monomer may include carboxylic acids (acrylic acid), hydroxy compounds (2-hydroxyethyl acrylate, 2-hydroxypropyl acrylate, and 4-hydroxybutyl acrylate), alkyls, alicyclic compounds (isobutyl acrylate, t-butyl acrylate, isooctyl acrylate, lauryl acrylate, stearyl acrylate, isobornyl acrylate, and cyclohexyl acrylate), other functional monomers (2-methoxyethyl acrylate, methoxy ethylene glycol acrylate, 2-ethoxyethyl acrylate, tetrahydrofurfuryl acrylate, benzyl acrylate, ethylcarbitol acrylate, phenoxyethyl acrylate, N,N-dimethylaminoethyl acrylate, N,N-dimethylaminopropyl acrylamide, N,N-dimethyl acrylamide, acryloylmorpholine, N-isopropylacrylamide, N,N-diethylacrylamide, N-vinylpyrrolidone, 2-(perfluorooctyl)ethyl acrylate, 3-perfluorohexyl-2-hydroxypropyl acrylate, 3-perfluorooctyl-2-hydroxypropyl acrylate, 2-(perfluorodecyl)ethyl acrylate, 2-(perfluoro-3-methylbutyl)ethyl acrylate), 2,4,6-tribromophenol acrylate, 2,4,6-tribromophenol methacrylate, 2-(2,4,6-tribromophenoxy)ethyl acrylate, and 2-ethylhexyl acrylate).

Examples of the bifunctional monomer may include tri(propylene glycol)diacrylate, trimethylolpropane diallyl ether, and urethane acrylate.

Examples of the polyfunctional monomer may include trimethylolpropane triacrylate, dipentaerythritol pentaacrylate, dipentaerythritol hexaacrylate, and ditrimethylolpropane tetraacrylate.

Examples of the initiator may include 2,2-dimethoxy-1,2-diphenylethane-1-one, 1-hydroxy-cyclohexyl phenyl ketone, and 2-hydroxy-2-methyl-l-phenylpropane-1-one.

From the viewpoint of, for example, the applicability and stability of the resin component and the smoothness of the coating, the solvent used is mixed into the resin composition. As the solvent, water or organic solvent can be used. More specifically, the solvent used is, for example, one or a mixture of two or more of: aromatic-based solvents such as toluene and xylene; alcohol-based solvents such as methyl alcohol, ethyl alcohol, n-propyl alcohol, iso-propyl alcohol, n-butyl alcohol, iso-butyl alcohol, and propylene glycol monomethyl ether; ester-based solvents such as methyl acetate, ethyl acetate, butyl acetate, and cellosolve acetate; ketone-based solvents such as acetone, methyl ethyl ketone, methyl isobutyl ketone, and cyclohexanone; glycol ethers such as 2-methoxyethanol, 2-ethoxyethanol, 2-butoxyethanol, ethylene glycol dimethyl ether, ethylene glycol diethyl ether, diethylene glycol dimethyl ether, and propylene glycol methyl ether; glycol ether esters such as 2-methoxyethyl acetate, 2-ethoxyethyl acetate, 2-butoxyethyl acetate, and propylene glycol methyl ether acetate; chlorine-based solvents such as chloroform, dichloromethane, trichloromethane, and methylene chloride; ether-based solvents such as tetrahydrofuran, diethyl ether, 1,4-dioxane, and 1,3-dioxolane; N-methylpyrrolidone; dimethylformamide; dimethyl sulfoxide; and dimethylacetamide. To suppress drying spots and cracks on the coated surface, a high-boiling point solvent may be further added to control the evaporation rate of the solvents. Examples of such a solvent may include butyl cellosolve, diacetone alcohol, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, and methyl glycol. These solvents may be used singly or in combination of two or more.

### (Application Step)

Next, the prepared resin composition 36 is applied to or printed on the surface of a substrate as shown in FIG. 6A. The application method used may be, for example, wire bar coating, blade coating, spin coating, reverse roll coating, die coating, spray coating, roll coating, gravure coating, micro-gravure coating, lip coating, air knife coating, curtain coating, a comma coating method, or a dipping method. The printing method used may be, for example, a letterpress printing method, an offset printing method, a gravure printing method, an intaglio printing method, a rubber plate printing method, an inkjet method, or a screen printing method.

### (Drying Step)

Next, if the resin composition 36 contains a solvent, the resin composition is dried to volatilize the solvent, as necessary. No particular limitation is imposed on the drying conditions, and any of natural drying and artificial drying in which drying temperature and drying time are controlled may be used. However, it is preferable that when wind is blown onto the surface of the coating during drying, the wind be blown such that no wind ripples occur on the coating surface. The drying temperature and the drying time can be appropriately determined from the boiling point of the solvent contained in the coating. In this case, it is preferable to select the drying temperature and the drying time within the range in which no deformation of the substrate 11 due to thermal contraction occurs, in consideration of the heat resistance of the substrate 11.

### (Curing Step)

Next, as shown in FIG. 6B, the master roll 31 and the resin composition 36 applied to the surface of the substrate 11 are brought into close contact with each other, and the resin composition 36 is cured. Then the substrate 11 integrated with the cured resin composition 36 is peeled off. In this manner, an anti-smudge substrate in which a plurality of protrusions 12a are formed on the surface of the substrate 11 is obtained, as shown in FIG. 6C. In this case, a base layer 12b may be further formed between the protrusions 12a and the substrate 11, if necessary.

Different curing methods are used for different types of resin compositions 36. When the resin composition 36 used is an energy ray-curable resin composition, the master roll 31 is pressed against the resin composition 35 to bring them into close contact with each other, and then the resin composition 36 is irradiated with energy rays such as ultraviolet rays (ultraviolet light) from an energy ray source 37 to thereby cure the resin composition 36.

No particular limitation is imposed on the energy ray source 37, so long as it can emit energy rays such as an electron beam, ultraviolet rays, infrared rays, a laser beam, visible light, gamma rays, ionizing radiation (X-rays, α-rays, β-rays, γ-rays, etc.), microwaves, or high-frequency waves, and ultraviolet rays are preferred from the viewpoint of a production facility. Preferably, the cumulative amount of irradiation is appropriately selected in consideration of the curing properties of the resin composition and suppression of yellowing of the resin composition and the substrate 11. Preferably, the atmosphere during irradiation is appropriately selected according to the type of the resin composition. Examples of the atmosphere may include air and inert gas atmospheres such as nitrogen and argon atmospheres.

When the substrate 11 is formed of a material that does not transmit energy rays such as ultraviolet rays, the master roll 31 may be formed of a material (for example, quartz) that can transmit the energy rays, and the resin composition 36 may be irradiated with the energy rays from the inner side of the master roll 31. The master for transfer is not limited to the master roll 31 described above, and a flat master may be used. However, from the viewpoint of improvement in mass productivity, it is preferable to use the above-described master roll 31 as the master for transfer.

When the resin composition 36 used is a thermosetting resin composition, the master roll 31 is pressed against the resin composition 36 to bring them into close contact with each other, and then the resin composition 36 is heated to its curing temperature using the master roll 31 to thereby cure the resin composition 36. In this case, a cooling roll may be pressed against the surface of the substrate 11 that is opposite to the side onto which the resin composition 36 is applied or printed to thereby prevent thermal defects in the substrate 11. The master roll 31 includes a heat source such as a heater disposed thereinside and is therefore configured so as to be capable of heating the resin composition 36 in close contact with the molding surface of the master roll 31.

### [Structure Forming Step Using Thermal Transfer Method]

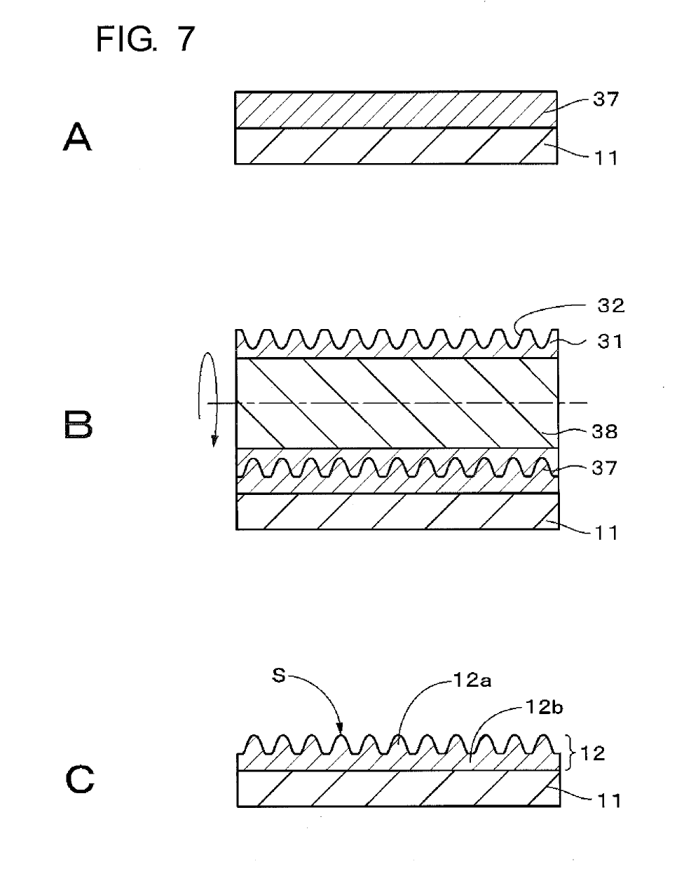

FIGS. 7A to 7C are process diagrams illustrating an example of the structure forming step using the thermal transfer method. First, as shown in FIG. 7A, a substrate 11 in which a resin layer 37 serving as a transfer layer is formed on its surface is formed. The resin layer 37 contains, for example, a thermoplastic resin composition. The thermoplastic resin composition contains at least one of the first compound and the second compound. When the thermoplastic resin composition contains the second compound, it is preferable that the thermoplastic resin composition further contain the third compound together with the second compound.

Next, as shown in FIG. 7B, the master roll 31 is pressed against the resin layer 37 to bring them into close contact with each other. Then, for example, the resin layer 37 is heated to near its glass transition point or to a temperature equal to or higher than the glass transition point to transfer the shape of the molding surface of the master roll 31. Next, the resin layer 37 with the shape transferred thereto together with the substrate 11 is peeled off the master roll 31. An anti-smudge substrate in which a plurality of protrusions 12a are formed on the surface of the substrate 11 is thereby obtained, as shown in FIG. 7C. In this case, a base layer 12b may be further formed between the protrusions 12a and the substrate 11, if necessary. In addition, a cooling roll may be pressed against the surface of the substrate 11 that is opposite to the side on which the resin layer 37 is disposed to thereby prevent thermal defects in the substrate 11.

### [Effects]

In the first embodiment, the anti-smudge layer 12 contains at least one of the first compound having an ester linkage in a portion other than its terminal ends and the second compound having a cyclic hydrocarbon group, and a plurality of protrusions 12a are disposed on the fingerprint resistant surface S of the anti-smudge layer 12. Therefore, when fingerprints adhere to the fingerprint resistant surface S of the anti-smudge substrate, the fingerprint patterns spread spontaneously and become less noticeable.

When the average height Hm of the protrusions 12a is 100 nm or smaller, fingerprints adhering to the fingerprint resistant surface S of the anti-smudge substrate can be made less noticeable by rubbing the fingerprints with, for example, a finger to spread them thinly. Therefore, the ease of wiping off fingerprints with a finger etc. can be improved. When the anti-smudge substrate or its anti-smudge layer 12 is applied to an electronic device such as an input device or a display device, fingerprints can become less noticeable over time during use of the device. Therefore, an electronic device having high fingerprint resistance can be provided.

### [Modifications]

In the first embodiment described above, the example of the configuration in which the anti-smudge layer 12 contains both the second compound having a cyclic hydrocarbon group and the third compound having a chain hydrocarbon group at a terminal end has been described. However, the present technique is not limited to this example. A configuration in which the anti-smudge layer 12 contains a fourth compound having a cyclic hydrocarbon group and a chain hydrocarbon group at a terminal end may be employed. Also in this case, the ease of wiping off fingerprints similar to that in the first embodiment described above can be obtained.

In the example of the configuration described in the above first embodiment, the anti-smudge layer 12 is provided adjacent to the surface of the substrate 11, but the configuration of the anti-smudge substrate is not limited to this example. Modifications of the anti-smudge substrate will next be described.

### (First Modification)

FIG. BA is a cross-sectional view illustrating an example of a configuration of an anti-smudge substrate according to a first modification. As shown in FIG. BA, this anti-smudge substrate is different from the anti-smudge substrate according to the first embodiment in that an anchor layer disposed between the substrate 11 and the anti-smudge layer 12 is further provided. When the anchor layer disposed between the substrate 11 and the anti-smudge layer 12 is provided as described above, the adhesion between the substrate 11 and the anti-smudge layer 12 can be improved. A plurality of protrusions 12a may be formed by providing protrusion-like fine structures on the surface of the anchor layer and forming an anti-smudge layer 12 so as to conform to the fine structures.

The material of the anchor layer used can be selected from, for example, a wide variety of known natural macromolecular resins and synthetic macromolecular resins. For example, transparent thermoplastic resin compositions, ionizing radiation irradiation compositions, and transparent curable resin compositions that are cured by heat can be used as the above resins. Examples of the usable thermoplastic resin composition may include polyvinyl chloride, vinyl chloride-vinyl acetate copolymers, polymethyl methacrylate, nitrocellulose, chlorinated polyethylene, chlorinated polypropylene, ethyl cellulose, and hydroxypropyl methyl cellulose. Examples of the usable transparent curable resin may include methacrylates, melamine acrylate, urethane acrylate, isocyanates, epoxy resin, and polyimide resin. The ionizing radiation used may be an electron beam, light (for example, ultraviolet rays or visible light), gamma rays, and X-rays, and ultraviolet rays are preferred from the viewpoint of a production facility.

The material of the anchor layer may further contain an additive. Examples of the additive may include a surfactant, a viscosity modifier, a dispersant, a curing-accelerating catalyst, a plasticizer, and stabilizers such as an antioxidant and an anti-sulfuration agent.

### (Second Modification)

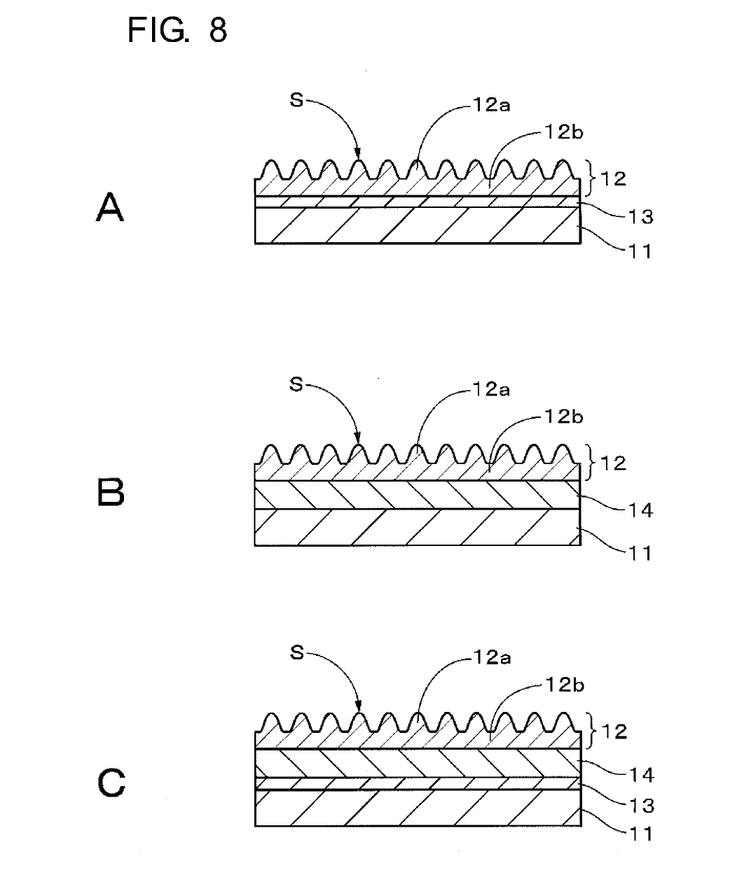

FIG. 8B is a cross-sectional view illustrating an example of a configuration of an anti-smudge substrate according to a second modification. As shown in. FIG. 8B, this anti-smudge substrate is different from the anti-smudge substrate according to the first embodiment in that a hard coating layer 14 disposed between the substrate 11 and the anti-smudge layer 12 is further provided. It is particularly preferable to provide the hard coating layer 14 when the substrate 11 used is a resin substrate such as a plastic film. When the hard coating layer 14 is disposed between the substrate 11 and the anti-smudge layer 12 as described above, practical properties (such as durability and pencil hardness) can be improved. A plurality of protrusions 12a may be formed by providing protrusion-like fine structures on the surface of the hard coating layer 14 and forming an anti-smudge layer 12 so as to conform to the fine structures.

The material of the usable hard coating layer 14 can be selected from, for example, a wide variety of known natural macromolecular resins and synthetic macromolecular resins. For example, transparent thermoplastic resin compositions and transparent curable resins that are cured by heat or irradiation with ionizing radiation can be used as the above resins. Examples of the usable thermoplastic resin composition may include polyvinyl chloride, vinyl chloride-vinyl acetate copolymers, polymethyl methacrylate, nitrocellulose, chlorinated polyethylene, chlorinated polypropylene, ethyl cellulose, and hydroxypropyl methyl cellulose. Examples of the usable transparent curable resin may include methacrylates, melamine acrylate, urethane acrylate, isocyanates, epoxy resin, and polyimide resin. The ionizing radiation used may be an electron beam, light (for example, ultraviolet rays or visible light), gamma rays, or X-rays, and ultraviolet rays are preferred from the viewpoint of a production facility.

The material of the hard coating layer 14 may further contain an additive. Examples of the additive may include a surfactant, a viscosity modifier, a dispersant, a curing-accelerating catalyst, a plasticizer, and stabilizers such as an antioxidant and an anti-sulfuration agent. The hard coating layer 14 may further contain light-scattering particles such as an organic resin filler that scatter light, in order to impart an AG (Anti-Glare) function to the fingerprint resistant surface S. In this case, the light-scattering particles may protrude from the surface of the hard coating layer 14 or the fingerprint resistant surface S of the anti-smudge layer 12 or may be covered with a resin contained in the hard coating layer 14 or the anti-smudge layer 12. The light-scattering particles may or may not be in contact with the substrate 11, which is a lower layer. Both the hard coating layer 14 and the anti-smudge layer 12 may further contain light-scattering particles. Instead of or in addition to the AG (Anti-Glare) function, an AR (Anti-Reflection) function may be imparted to the anti-smudge substrate. The AR (Anti-Reflection) function can be imparted by, for example, forming an AR layer on the hard coating layer 14. The AR layer used may be, for example, a single low-refractive index layer film or a multilayer film formed by alternately stacking low-refractive index layers and high-refractive index layers.

### (Third Modification)

FIG. 80 is a cross-sectional view illustrating an example of a configuration of an anti-smudge substrate according to a third modification. As shown in FIG. 8C, this anti-smudge substrate is different from the anti-smudge substrate according to the first embodiment in that a hard coating layer 14 disposed between the substrate 11 and the anti-smudge layer 12 and an anchor layer disposed between the substrate 11 and the hard coating layer 14 are further provided. It is particularly preferable to provide the hard coating layer 14 when the substrate 11 used is a resin substrate such as a plastic film.

### (Fourth Modification)

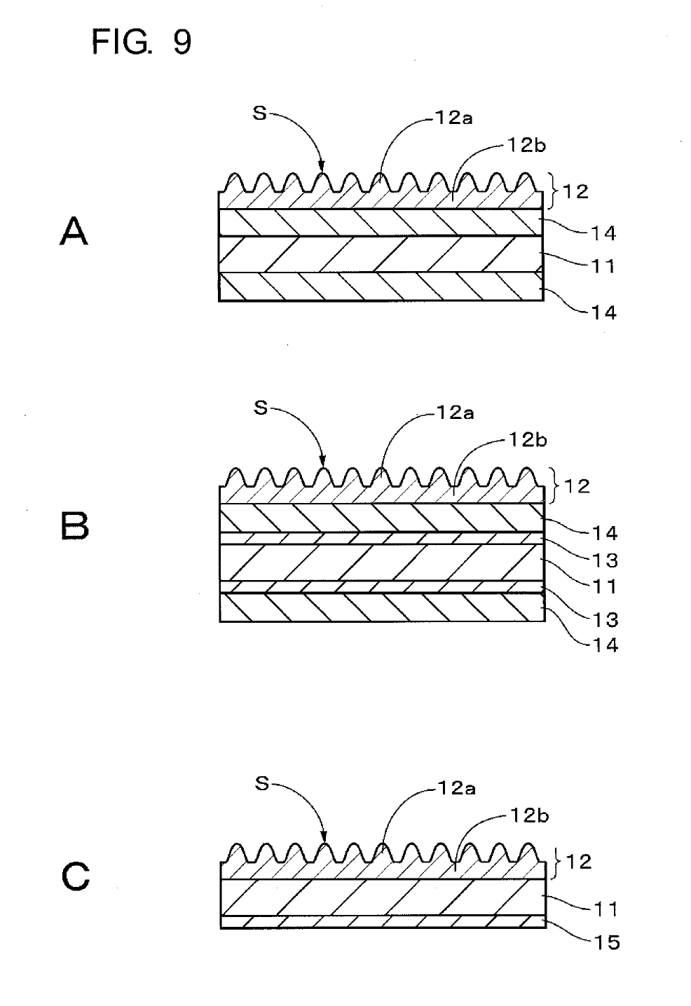

FIG. 9A is a cross-sectional view illustrating an example of a configuration of an anti-smudge substrate according to a fourth modification. As shown in FIG. 9A, this anti-smudge substrate is different from the anti-smudge substrate according to the first embodiment in that hard coating layers 14 are further provided on both the surfaces of the substrate 11. The anti-smudge layer 12 is disposed on the surface of one of the hard coating layers 14 disposed on both the surfaces of the substrate 11. It is particularly preferable to provide the hard coating layers 14 when the substrate 11 used is a resin substrate such as a plastic film.

### (Fifth Modification)

FIG. 9B is a cross-sectional view illustrating an example of a configuration of an anti-smudge substrate according to a fifth modification. As shown in FIG. 9B, this anti-smudge substrate is different from the anti-smudge substrate according to the first embodiment in that anchor layers and hard coating layers 14 are further provided on both the surfaces of the substrate 11. Each anchor layer is disposed between the substrate 11 and a hard coating layer 14. The anti-smudge layer 12 is disposed on the surface of one of the hard coating layers 14 disposed on both the surfaces of the substrate 11. It is particularly preferable to provide the hard coating layers 14 when the substrate 11 used is a resin substrate such as a plastic film.

### (Sixth Modification)

FIG. 9C is a cross-sectional view illustrating an example of a configuration of an anti-smudge substrate according to a sixth modification. This anti-smudge substrate is an anti-smudge transparent conductive substrate and is different from the anti-smudge substrate according to the first embodiment in that a transparent conductive layer 15 is further provided on the surface of the substrate 11 that is opposite to the anti-smudge layer 12, as shown in FIG. 9C. The transparent conductive layer 15 may be a transparent electrode having a prescribed electrode pattern. Examples of the electrode pattern may include, but are not limited to, a stripe pattern. An over-coating layer may be further provided on the surface of the transparent conductive layer 15, if necessary. A hard coating layer and/or an anchor layer may be further provided between the substrate 11 and the transparent conductive layer 15, if necessary.

The material used for the transparent conductive layer 15 may be, for example, at least one selected from the group consisting of electrically conductive metal oxide materials, electrically conductive metal materials, electrically conductive carbon materials, and conductive polymers. Examples of the metal oxide materials may include indium tin oxide (ITO), zinc oxide, indium oxide, antimony-doped tin oxide, fluorine-doped tin oxide, aluminum-doped zinc oxide, gallium-doped zinc oxide, silicon-doped zinc oxide, zinc oxide-tin oxide based materials, indium oxide-tin oxide based materials, and zinc oxide-indium oxide-magnesium oxide based materials. The metal material used may be, for example, a metal nano-filler such as metal nanoparticles and metal nanowires. Specific examples of the metal material may include: metals such as copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead; and alloys of these metals. Examples of the carbon materials may include carbon black, carbon fibers, fullerenes, graphene, carbon nanotubes, carbon microcoils, and carbon nanohorns. Examples of the conductive polymers may include substituted or unsubstituted polyaniline, substituted or unsubstituted polypyrrole, substituted or unsubstituted polythiophene, and (co)polymers composed of one or two selected from these polymers.

The method used to form the transparent conductive layer 15 may be, for example, a PVD method such as a sputtering method, a vacuum deposition method, or an ion plating method, a CVD method, a coating method, or a printing method, but the method used is not limited thereto.

### 2. Second Embodiment

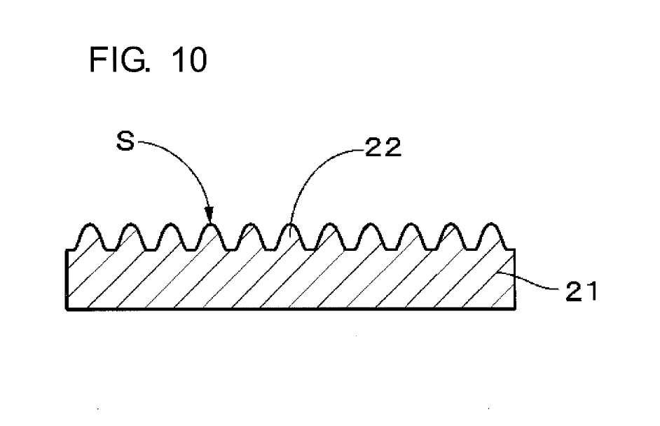

FIG. 10 is a cross-sectional view illustrating an example of a configuration of an anti-smudge substrate according to the second embodiment of the present technique. As shown in FIG. 10, this anti-smudge substrate is different from that in the first embodiment in that a substrate 21 is formed integrally with a plurality of protrusions 22. The material used for the substrate 21 and the protrusions 22 is the same as the material for the anti-smudge layer 12 in the first embodiment described above. Specifically, it is preferable to use a material containing a thermoplastic resin composition as the material of the substrate 21 and the protrusions 22. Preferably, in this case, the thermoplastic resin composition contains at least one of the first compound and the second compound. The substrate 21 and the protrusions 22 are the same as the substrate 11 and the protrusions 12a in the first embodiment described above except for the material constituting them.

The method used to produce the anti-smudge substrate may be, for example, a melt extrusion method, a transfer method, etc. The melt extrusion method used may be, for example, a method in which, immediately after the thermoplastic resin composition is discharged from a die into a film shape, the thermoplastic resin composition is nipped between two rolls to transfer the surface shape of the roll to the resin material. One of the two rolls used may be the master roll 31 in the first embodiment described above. The transfer method used may be, for example, a thermal transfer method in which the molding surface of a master is pressed against the substrate and the substrate is heated to near its glass transition point or to a temperature equal to or higher than the glass transition point to thereby transfer the shape of the molding surface of the master. The master used may be the master roll 31 in the first embodiment described above.

### [Effects]

In the second embodiment, the substrate 21 and the plurality of protrusions 22 are formed integrally with each other, so that the configuration of the anti-smudge substrate can be simplified. When the substrate 21 and the plurality of protrusions 22 are transparent, reflection from the interface between the substrate 21 and the plurality of protrusions 22 can be suppressed.

### 3. Third Embodiment

### [Configuration of Anti-Smudge Substrate]

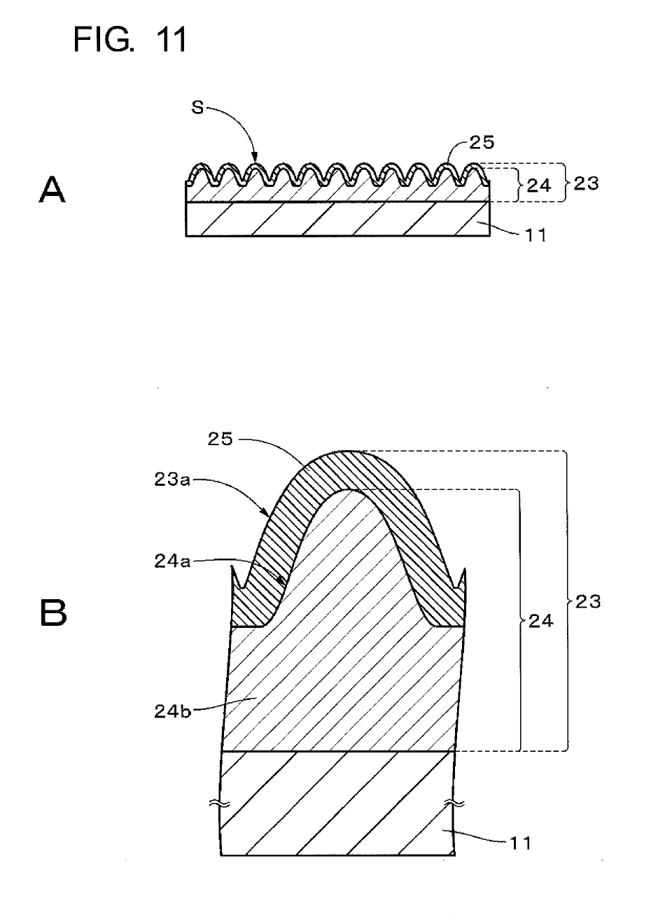

FIG. 11A is a cross-sectional view illustrating an example of a configuration of an anti-smudge substrate according to a third embodiment of the present technique. FIG. 11B is an enlarged cross-sectional view of part of FIG. 11A. This anti-smudge substrate includes a substrate 11 and an anti-smudge structure layer 23 provided on the surface of the substrate 11. The anti-smudge structure layer 23 includes a fine structure layer 24 provided on the surface of the substrate 11 and an anti-smudge layer 25 provided on the fine structure surface of the fine structure layer 24. In the third embodiment, the same portions as those in the first embodiment are denoted by the same reference numerals, and the description thereof is omitted.

A plurality of surface protrusions (first protrusions) 23a are provided on the fingerprint resistant surface S of the anti-smudge layer 25. A plurality of inner protrusions (second protrusions) 24a are provided on the surface of the fine structure layer 24. The surface protrusions 23a are configured by disposing the anti-smudge layer 25 so as to conform to the inner protrusions 24a. The arrangement, shape, arrangement pitch (average arrangement pitch), height (average height), aspect ratio (average aspect ratio), etc. of the surface protrusions 23a are the same as those of the protrusions 12a in the first embodiment described above. If necessary, the fine structure layer 24 may further include a base layer 24b between the surface of the substrate 11 and the inner protrusions 24a. This anti-smudge substrate may have a configuration in which the substrate 11 and the fine structure layer 24 are integrally formed with each other.

The material of the anti-smudge layer 25 is the same as the material of the anti-smudge layer 12 in the first embodiment. The fine structure layer 24 may be a functional layer such as an anchor layer or a hard coating layer. The material used for the fine structure layer 24 may be at least one of an energy ray-curable resin composition, a thermosetting resin composition, and a thermoplastic resin composition. The thickness of the anti-smudge layer 12 is selected such that, for example, when the anti-smudge layer 25 is formed on the surface of the fine structure layer 24, the shape of the inner protrusions 24a is not embedded in the fine structure layer 24. Specifically, the thickness of the anti-smudge layer 25 is, for example, equal to or larger than a monolayer thickness and 10 μm or smaller, preferably equal to or larger than the monolayer thickness and 1 μm or smaller, and particularly preferably equal to or larger than the monolayer thickness and 100 nm or smaller.

### [Method of Producing Anti-Smudge Substrate]

Next, a method of producing the anti-smudge substrate having the above-described configuration will be described.

First, the inner protrusions 24a are formed on the surface of the substrate 11 in the same manner as in the first embodiment described above except that a conventionally known energy ray-curable resin or thermosetting resin not containing any of the above described first compound and second compound is used. However, the height, aspect ratio, etc. of the inner protrusions 24a are set such that the height, aspect ratio, etc. of the surface protrusions 23a formed in the subsequent step become the same as those of the protrusions 12a in the first embodiment described above. In this step, a base layer 24b may be provided between the surface of the substrate 11 and the inner protrusions 24a, if necessary.

Next, a resin composition containing at least one of the first compound having an ester linkage in a portion other than its terminal ends and the second compound having a cyclic hydrocarbon group is prepared. This resin composition used may be the same resin composition as that used to form the anti-smudge layer 12 in the first embodiment described above.

Next, the prepared resin composition is applied to or printed onto the surface of the substrate 11 having the plurality of inner protrusions 24a disposed thereon. In this case, the resin composition is applied or printed so as to conform to the surface shape of the inner protrusions 24a. When the next step includes a drying step, the resin composition may conform to the surface shape of the inner protrusions 24a after the drying step. Next, if necessary, the resin composition is dried and then cured. The anti-smudge layer 25 is thereby formed on the plurality of inner protrusions 24a so as to conform to the surface of these inner protrusions 24a. Specifically, a fingerprint resistant surface S with the plurality of surface protrusions 23a is formed on the surface of the substrate 11. The intended anti-smudge substrate is obtained in the manner described above.

### [Effects]

In the third embodiment, the anti-smudge layer 25 is disposed so as to conform to the plurality of inner protrusions 24a of the fine structure layer 24, and the plurality of surface protrusions 23a are formed on the fingerprint resistant surface S. Therefore, the same effects as those of the first embodiment described above can be obtained.

### 4. Fourth Embodiment

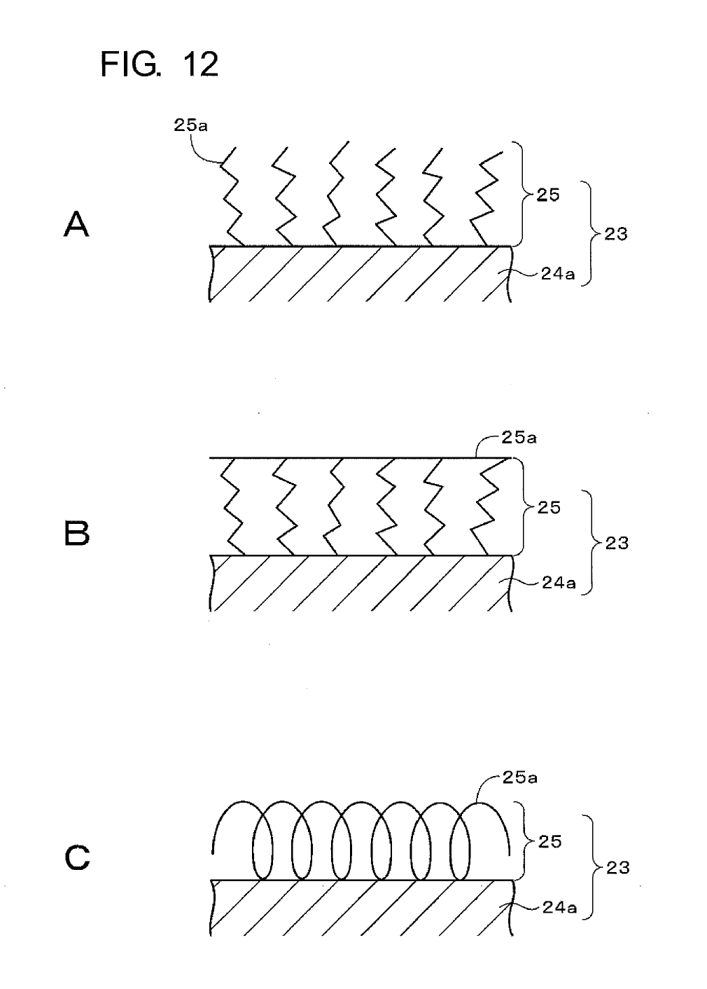

FIGS. 12A to 12C are schematic diagrams illustrating examples of configurations of an anti-smudge substrate according to a fourth embodiment of the present technique. The anti-smudge substrate according to the fourth embodiment is different from the anti-smudge substrate according to the third embodiment in that an adsorption compound 25a is adsorbed on the surface of the inner protrusions 24a to thereby form an anti-smudge layer 25. A functional layer (such as an anchor layer or a hard coating layer) other than the anti-smudge layer 25 may be provided on the surface of the substrate 11. The anti-smudge layer 25 is, for example, a monomolecular layer formed from the adsorption compound 25a. The region on which the adsorption compound 25a is adsorbed is not limited to one of the surfaces of the substrate 11 where the inner protrusions 24a are disposed, and the adsorption compound 25a may be adsorbed on both the surfaces of the substrate 11 or part of the surfaces. The adsorption compound 25a may be adsorbed selectively on a surface or a predetermined region that are frequently touched with a hand, a finger, etc.

The site of the adsorption compound 25a that is adsorbed on the surface of the inner protrusions 24a may be any of the terminal ends of the side and main chains of the adsorption compound 25a, and both a terminal end of a side chain and a terminal end of the main chain may be adsorbed on the surface of the substrate 11. FIG. 12A shows a configuration in which one terminal end of the main chain of the adsorption compound 25a is adsorbed on the surface of the inner protrusions 24a. FIG. 12B shows a configuration in which terminal ends of side chains of the adsorption compound 25a are adsorbed on the surface of the inner protrusions 24a. FIG. 12C shows a configuration in which the main chain of the adsorption compound 25a is adsorbed on the surface of the inner protrusions 24a. The adsorption may be any of physical adsorption and chemical adsorption. From the viewpoint of durability, chemical adsorption is preferred. Specific examples of the adsorption may include adsorption through an acid-base reaction, a covalent bond, an ionic bond, a hydrogen bond, etc.

The adsorption compound 25a used may be prepared by adding an adsorption group that adsorbs on the surface of the substrate 11 to, for example, the first and second compounds in the first embodiment described above. The position at which the adsorption group is attached may be any of the terminal ends and side chains of the adsorption compound 25a, and a plurality of adsorption groups may be added to one molecule of the adsorption compound 25a.

Any adsorption group may be used so long as it can be adsorbed to the inner protrusions 24a. Specific examples of the adsorption group may include a sulfo group (including sulfonates), a sulfonyl group, a carboxylic acid group (including carboxylates), an amino group, a phosphoric acid group (including phosphates and phosphoric esters), a phosphino group, an epoxy group, an isocyanate group, and a thiol group. It is sufficient that at least one such adsorption group be present in the adsorption compound 25a.

A compound having, in its molecule, a structure represented by the formula (7) below can be used as the first compound having an adsorption group.

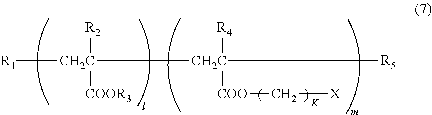

In the formula (7), X is, for example, a sulfo group (including a sulfonate), a sulfonyl group, a carboxylic acid group (including a carboxylate), an amino group, a phosphoric acid group (including a phosphate and a phosphoric ester), a phosphino group, an epoxy group, an isocyanate group, a thiol group, and the like.

A compound having, in its molecule, a structure represented by the formula (8) below can be used as the second compound having an adsorption group.

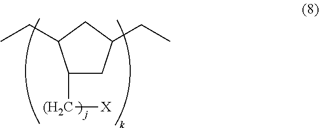

In the formula (8), X is, for example, a sulfo group (including a sulfonate), a sulfonyl group, a carboxylic acid group (including a carboxylate), an amino group, a phosphoric acid group (including a phosphate and a phosphoric ester), a phosphino group, an epoxy group, an isocyanate group, a thiol group, and the like.

A compound having, in its molecule, a structure represented by the formula (9) below can be used as the third compound having an adsorption group.

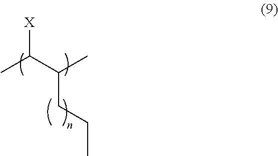

In the formula (9), X is, for example, a sulfo group (including a sulfonate), a sulfonyl group, a carboxylic acid group (including a carboxylate), an amino group, a phosphoric acid group (including a phosphate and a phosphoric ester), a phosphino group, an epoxy group, an isocyanate group, a thiol group, and the like.

### [Method of Producing Anti-Smudge Substrate]

A description will next be given of an example of a method of producing the anti-smudge substrate using a wet process.

### (Preparation of Processing Solution)

First, the adsorption compound 25a is dissolved in a solvent to prepare a processing solution. When the adsorption compound 25a is liquid at room temperature or is subjected to, for example, heat treatment to obtain the adsorption compound 25a in a liquid state, the adsorption compound 25a may be used as it is without dissolving in a solvent. When the processing solution comes close to the surface of the inner protrusions 24a, the adsorption compound 25a is adsorbed on the surface. The adsorption rate increases as the amount of the adsorption compound in the processing solution increases. Therefore, the higher the concentration of the compound is, the more it is preferred. Specifically, the concentration of the compound is preferably 0.01% by mass or more.

The solvent used may be appropriately selected from those that can dissolve the adsorption compound 25a at a prescribed concentration. More specifically, the solvent used is, for example, one or a mixture of two or more of: aromatic-based solvents such as toluene and xylene; alcohol-based solvents such as methyl alcohol, ethyl alcohol, n-propyl alcohol, iso-propyl alcohol, n-butyl alcohol, iso-butyl alcohol, and propylene glycol monomethyl ether; ester-based solvents such as methyl acetate, ethyl acetate, butyl acetate, and cellosolve acetate; ketone-based solvents such as acetone, methyl ethyl ketone, methyl isobutyl ketone, and cyclohexanone; glycol ethers such as 2-methoxyethanol, 2-ethoxyethanol, 2-butoxyethanol, ethylene glycol dimethyl ether, ethylene glycol diethyl ether, diethylene glycol dimethyl ether, and propylene glycol methyl ether; glycol ether esters such as 2-methoxyethyl acetate, 2-ethoxyethyl acetate, 2-butoxyethyl acetate, and propylene glycol methyl ether acetate; chlorine-based solvents such as chloroform, dichloromethane, trichloromethane, and methylene chloride; ether-based solvents such as tetrahydrofuran, diethyl ether, 1,4-dioxane, and 1,3-dioxolane; N-methylpyrrolidone; dimethylformamide; dimethyl sulfoxide; and dimethylacetamide.

### (Adsorption)

Next, for example, the substrate 11, which is a processing target, is immersed in the processing solution, or a prescribed amount of the processing solution is applied to or printed on one of or both the surfaces of the substrate 11 used as the processing target.

The coating method used may be, for example, wire bar coating, blade coating, spin coating, reverse roll coating, die coating, spray coating, roll coating, gravure coating, micro-gravure coating, lip coating, air knife coating, curtain coating, a comma coating method, or a dipping method. The printing method used may be, for example, a letterpress printing method, an offset printing method, a gravure printing method, an intaglio printing method, a rubber plate printing method, an inkjet method, or a screen printing method.

When an immersion method is used, the processing solution in an amount sufficient to allow the substrate 11 used as the processing target to be immersed therein is prepared, and it is preferable that the substrate 11 be immersed in the processing solution for 0.1 seconds to 48 hours. If necessary, after immersion, the substrate 11 may be washed with a good solvent for the adsorption compound 25a to rinse out the unadsorbed adsorption compound 25a. Then the resultant substrate 11 is dried as needed, and the adsorption processing is thereby completed. The drying method may be, for example, any of natural drying and artificial drying using a heating apparatus. When heat treatment and/or ultrasonic treatment is performed during immersion of the substrate 11 used as the processing target, the rate of adsorption of the adsorption compound 25a can be increased.

When a coating method is used, heat treatment and/or ultrasonic treatment may also be performed on the substrate 11 when the processing solution is applied to the substrate 11. If necessary, after application, the substrate 11 may be washed with a good solvent for the adsorption compound 25a to rinse out the unadsorbed adsorption compound 25a. Then the resultant substrate 11 is dried as needed, and the adsorption processing is thereby completed. The drying method may be, for example, any of natural drying and artificial drying using a heating apparatus. It is not necessary to achieve the desired amount of application of the processing solution only by one application step, and the desired amount of application of the processing solution may be achieved by repeating the above application and washing steps a plurality of times.

### (Effects)

In the fourth embodiment, the adsorption compound 25a is adsorbed on the surface of the inner protrusions 24a to form the anti-smudge layer 25 on the surface of the inner protrusions 24a. Therefore, the same effects as those in the first embodiment described above can be obtained.

### [Modification]

In the third and fourth embodiments described above, the method using a wet process has been described as an example of the method of producing the anti-smudge substrate. The method of producing the anti-smudge substrate is not limited to this example, and a dry process can also be used. More specifically, a dry process can be used to form the anti-smudge layer 12 in the third embodiment or the fourth embodiment described above directly on the surface of the inner protrusions 24a.

The dry process used may be, for example, a sputtering method, a thermal CVD (Chemical Vapor Deposition) method, a plasma CVD method, an ALD (Atomic Layer Deposition) method, an ion plating method, etc.

### 5. Fifth Embodiment

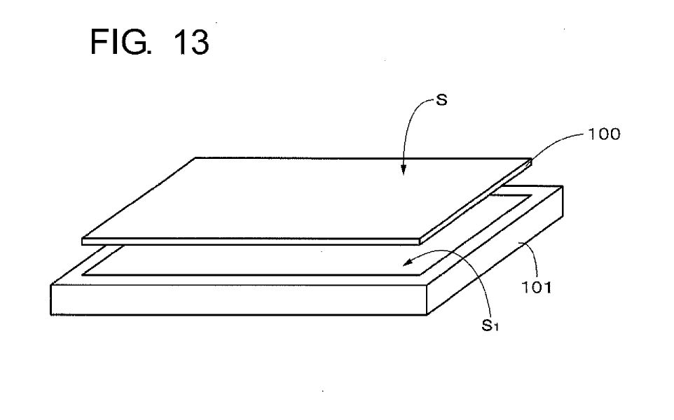

FIG. 13 is a perspective view illustrating an example of a configuration of a display device according to a fifth embodiment of the present technique. As shown in FIG. 13, an anti-smudge body 100 is provided on a display surface S₁ of the display device 101. Examples of the anti-smudge body 100 used may include an anti-smudge layer, an anti-smudge structure layer, and an anti-smudge substrate. Examples of the anti-smudge layer used may include the anti-smudge layer 12 according to the first embodiment. Examples of the anti-smudge structure layer used may include the anti-smudge structure layer 23 according to the third or fourth embodiment. Examples of the anti-smudge substrate used may include the anti-smudge substrates according to the first to the fourth embodiments. When the anti-smudge substrate is used as an anti-smudge body, a configuration in which the anti-smudge substrate is bonded to the display surface S₁ of the display device 101 through a bonding layer can be used. When this configuration is used, it is preferable to use, for example, a transparent and flexible sheet as the substrate 11 of the anti-smudge substrate.

The display device 101 used may be any of various display devices such as a liquid crystal display, a CRT (Cathode Ray Tube) display, a plasma display (Plasma Display Panel: PDP), an electro luminescent (Electro Luminescence: EL) display, and a surface-conduction electron-emitter display (Surface-conduction Electron-emitter Display: SED).

### [Effects]

In the fifth embodiment, since the display surface S₁ of the display device 101 can serve as the fingerprint resistant surface S, fingerprints etc. adhering to the display surface S₁ of the display device 101 can be made less noticeable by allowing the fingerprint patterns to spontaneously spread. Therefore, the visibility of the display device 101 can be improved.

When the average height Hm of the protrusions 12a is 100 nm or smaller, fingerprints adhering to the display surface S₁ of the display device 101 can be made less noticeable by rubbing the fingerprints with, for example, a finger to spread them thinly. Therefore, the visibility of the display device 101 can be further improved.

### 6. Sixth Embodiment

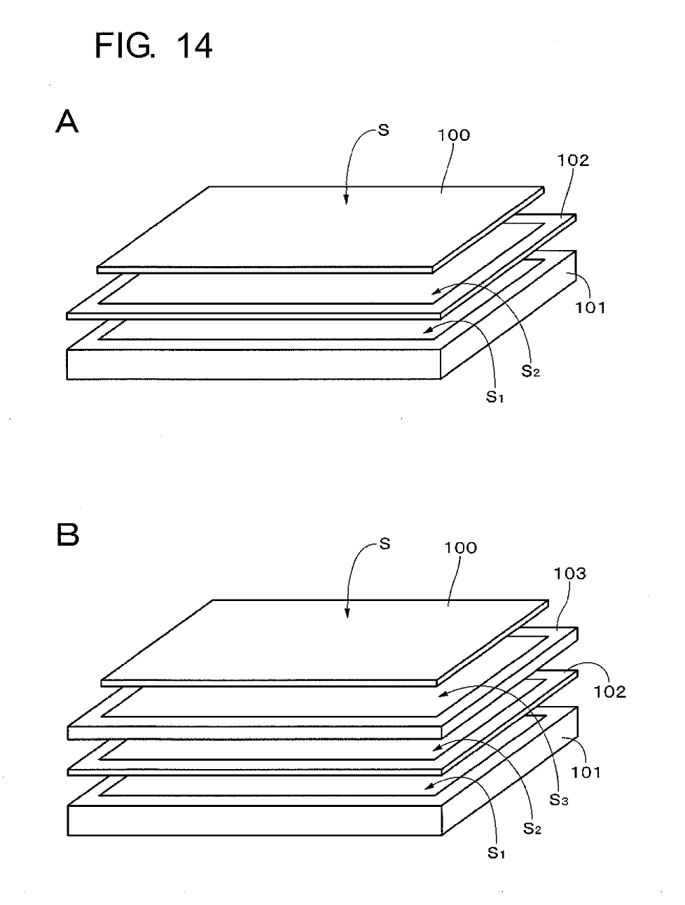

FIG. 14A is a perspective view illustrating an example of a configuration of a display device according to a sixth embodiment of the present technique. As shown in FIG. 14A, an input device 102 is disposed on the display surface S₁ of the display device 101. An anti-smudge body 100 is disposed on an input surface S₂ of the input device 102. The display device 101 and the input device 102 are bonded to each other through a bonding layer formed of, for example, an adhesive. Examples of the anti-smudge body 100 used may include an anti-smudge layer, an anti-smudge structure layer, and an anti-smudge substrate. Examples of the anti-smudge layer used may include the anti-smudge layer 12 according to the first embodiment. Examples of the anti-smudge structure layer used may include the anti-smudge structure layer 23 according to the third or fourth embodiment. Examples of the anti-smudge substrate used may include the anti-smudge substrates according to any of the first to the fourth embodiments. When the anti-smudge substrate is used as an anti-smudge body, a configuration in which the anti-smudge substrate is bonded to the input surface S₂ of the input device 102 through a bonding layer can be used. When this configuration is used, it is preferable to use, for example, a transparent and flexible sheet as the substrate 11 of the anti-smudge substrate.

The input device 102 can employ, for example, a resistive film type or capacitive type touch panel, but is not limited thereto. Examples of the resistive film type touch panel may include a matrix resistive film type touch panel. Examples of the capacitive type touch panel may include a projection capacitive type touch panel of the Wire Sensor mode and a projection capacitive type touch panel of the ITO Grid mode.

### [Effects]

In the sixth embodiment, the input surface S₂ of the input device 102 can serve as the fingerprint resistant surface S, so that fingerprints etc. adhering to the input surface S₂ of the input device 102 can be made less noticeable by allowing the fingerprint patterns to spontaneously spread. Therefore, the visibility of the display device 101 equipped with the input device 102 can be improved.

When the average height Hm of the protrusions 12a is 100 nm or smaller, fingerprints adhering to the input surface S₂ of the input device 102 can be made less noticeable by rubbing the fingerprints with, for example, a finger to spread them thinly. Therefore, the visibility of the display device 101 provided with the input device 102 can be further improved.

### [Modification]

FIG. 14B is an exploded perspective view illustrating an example of a configuration of a modification of the input device according to the sixth embodiment of the present technique. As shown in FIG. 14B, a front panel (surface member) 103 may be provided on the input surface S₂ of the input device 102. In this case, an anti-smudge body 100 is provided on a panel surface S₃ of the front panel 103. The input device 102 and the front panel (surface member) 103 are bonded to each other through a bonding layer formed of, for example, an adhesive.

### 7. Seventh Embodiment

An electronic device according to a seventh embodiment of the present technique includes a display device 101 according to the fifth embodiment, the sixth embodiment, or its modification. If necessary, an anti-smudge body is provided on the surface of the casing of this electronic device. Examples of the anti-smudge body used may include an anti-smudge layer, an anti-smudge structure layer, and an anti-smudge substrate. Examples of the anti-smudge layer used may include the anti-smudge layer 12 according to the first embodiment. Examples of the anti-smudge structure layer used may include the anti-smudge structure layer 23 according to the third or fourth embodiment. Examples of the anti-smudge substrate used may include the anti-smudge substrates according to the first to the fourth embodiments. The anti-smudge substrate itself may form the casing of the electronic device.

An example of the electronic device according to the seventh embodiment of the present technique will next be described.

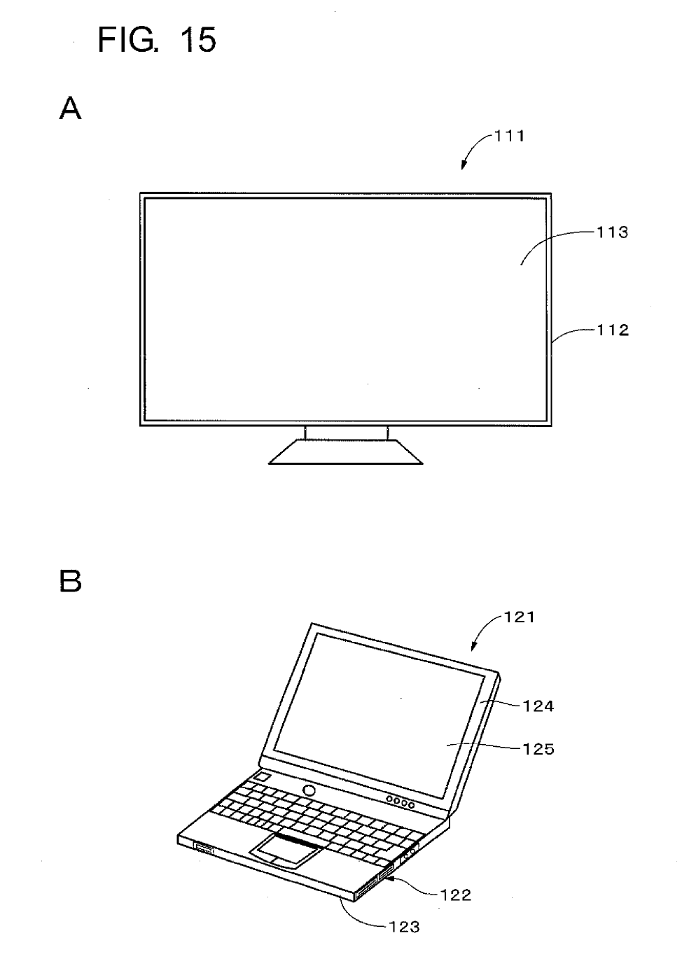

FIG. 15A is an external view illustrating a television set, which is an example of the electronic device. The television set 111 includes a casing 112 and a display device 113 contained in the casing 112. The display device 113 is a display device 101 according to the fifth embodiment, the sixth embodiment, or its modification. If necessary, an anti-smudge body may be provided on the surface of the casing 112, or the casing 112 itself may be formed from an anti-smudge substrate.

FIG. 15B is an external view illustrating a notebook-type personal computer, which is an example of the electronic device. The notebook-type personal computer 121 includes a computer main body 122 and a display device 125. The computer main body 122 and the display device 125 are contained in a casing 123 and a casing 124, respectively. The display device 125 is a display device 101 according to the fifth embodiment, the sixth embodiment, or its modification. If necessary, an anti-smudge body may be provided on the surfaces of the casing 123 and the casing 124, and the casing 123 and the casing 124 themselves may be formed from an anti-smudge substrate.

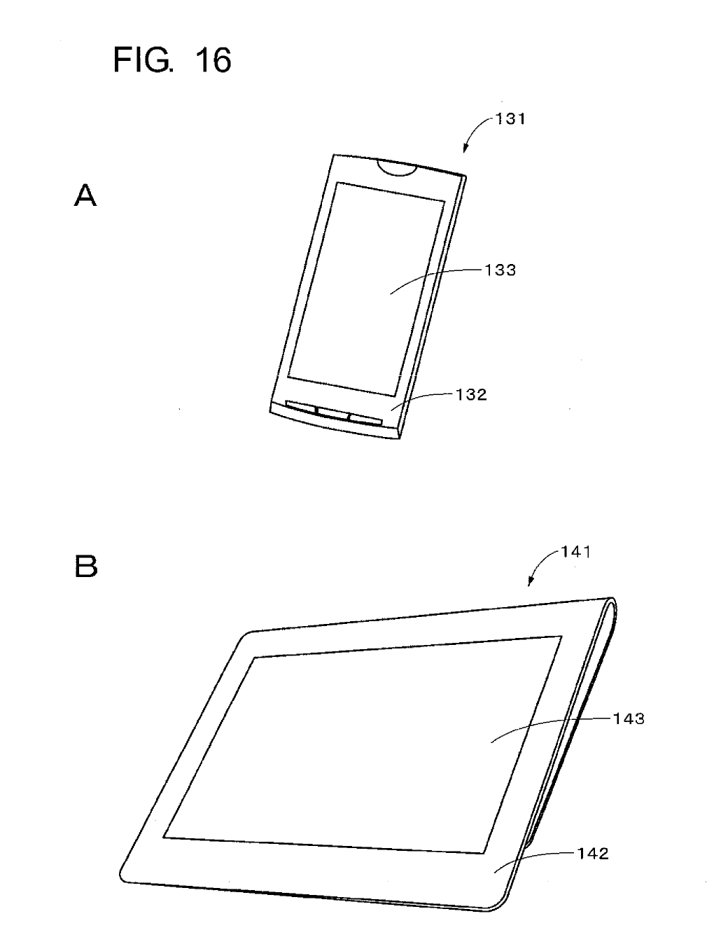

FIG. 16A is an external view illustrating a cellular phone, which is an example of the electronic device. The cellular phone 131 is a so-called smart phone, and includes a casing 132 and a display device 133 contained in the casing 132. The display device 133 is a display device 101 according to the sixth embodiment, or its modification. If necessary, an anti-smudge body may be provided on the surface of the casing 132, or the casing 132 itself may be formed from an anti-smudge substrate.

FIG. 16B is an external view illustrating a tablet-type computer, which is an example of the electronic device. The tablet-type computer 141 includes a casing 142 and a display device 143 contained in the casing 142. The display device 143 is a display device 101 according to the sixth embodiment, or its modification. If necessary, an anti-smudge body may be provided on the surface of the casing 142, or the casing 142 itself may be formed from an anti-smudge substrate.

### [Effects]

In the seventh embodiment, the electronic device includes the display device 101 according to the fifth embodiment, the sixth embodiment, or its modification, so that the visibility of the display device 101 of the electronic device can be improved. When the average height Hm of the protrusions 12a is 100 nm or smaller, the visibility of the display device 101 of the electronic device can be further improved.

When an anti-smudge body is provided on the surface of the casing of the electronic device, if fingerprints adhere to the surface of the casing of the electronic device, the fingerprint patterns spontaneously spread thinly and become less noticeable. Therefore, smudges on the surface of the casing can be made less noticeable. When the average height Hm of the protrusions 12a is 100 nm or smaller, fingerprints adhering to the surface of the casing of the electronic device can be made less noticeable by rubbing the fingerprints with, for example, a finger to spread them thinly. Therefore, the smudges on the surface of the casing can be made further less noticeable.

### EXAMPLES

The present technique will next be specifically described by way of Examples. However, the present technique is not limited only to these Examples.

In the following Examples, the average arrangement pitch, average height, and average aspect ratio of protrusions were determined as follows.

First, a fingerprint resistant surface having protrusions was observed under an atomic force microscope (AFM), and pitches and heights of protrusions were determined from an AFM cross sectional profile. This procedure was repeated for 10 regions randomly selected on the fingerprint resistant surface to determine arrangement pitches P1, P2, . . . , P10 and heights H1, H2, . . . , H10. The pitch of protrusions is the distance between the apexes of the protrusions, and the heights of the protrusions are their heights with reference to the lowest point in recessed portions (valley portions) between the protrusions. Then the pitches and heights were simply averaged (arithmetically averaged) to determine the average arrangement pitch Pm and average height Hm of the protrusions. Next, the average aspect ratio Hm/Pm was determined from the determined average arrangement pitch Pm and average height Hm.

### Example 1

First, a glass master roll with an outer diameter of 126 mm was prepared, and a resist layer was formed on the surface of the glass master roll in the following manner. Specifically, a photo-resist was diluted 1/10 with a thinner, and the columnar surface of the glass master roll was coated with the diluted resist to a thickness of about 70 nm by a dipping method to thereby form a resist layer. Next, the glass master roll serving as a recording medium was conveyed to the master roll exposure apparatus shown in FIG. 3, and the resist layer was exposed to light to pattern the resist layer such that latent images were arranged on one helix with adjacent three tracks forming a hexagonal lattice pattern. Specifically, a region in which a hexagonal lattice-like exposure pattern was to be formed was irradiated with laser light to thereby form the hexagonal lattice-like exposure pattern. The power of the laser light was 0.50 mW/m, which allowed the surface of the glass master roll to be exposed to the laser light.

Next, the resist layer on the glass master roll was subjected to development treatment, i.e., portions of the resist layer exposed to the light were dissolved to perform development. Specifically, the undeveloped glass master roll was placed on a turntable of an unillustrated development apparatus, and a developer was dropped onto the surface of the glass master roll while the turntable together with the glass master roll was rotated to thereby develop the resist layer on the surface. In this manner, a resist glass master in which openings arranged in a hexagonal lattice pattern were formed on the resist layer was obtained.

Next, plasma etching was performed in a CHF₃ gas atmosphere using a roll etching apparatus. The etching proceeded only in hexagonal lattice pattern regions exposed from the resist layer on the surface of the glass master roll, and the other regions were not etched because the resist layer served as a mask, whereby elliptical cone-shaped recessed portions were formed in the glass master roll. In this case, the amount (depth) of etching was controlled by etching time. Finally, the resist layer was completely removed by O₂ asking, and a glass master roll with a hexagonal lattice pattern of recessed portions was thereby obtained. In this glass master roll, the depth of the recessed portions in an inter-track direction was larger than the depth of the recessed portions in the extending direction of the tracks.

Next, the master roll obtained as described above was used to form a plurality of protrusions two-dimensionally on the surface of a ZEONOR film (registered trademark, manufactured by Zeon Corporation) by UV imprinting. Specifically, the master roll obtained as described above was brought into close contact with the ZEONOR film coated with an ultraviolet-curable resin composition (hereinafter referred to as a “UV-curable resin”) having the following chemical composition, and the ZEONOR film was peeled off while the UV-curable resin was cured by UV irradiation. An optical film in which a plurality of protrusions (inner protrusions) with the following configuration were arranged on its surface was thereby obtained.

### (Chemical Composition of UV-Curable Resin)

Polyester acrylate oligomer (product name: CN2302, manufactured by Sartomer): 95% by mass

Photo-polymerization initiator (product name: IRGACURE-184, manufactured by BASF Japan Ltd.: 5% by mass

### (Configuration of Protrusions)

Arrangement of protrusions: Closest packed (hexagonal lattice)

Shape of protrusions: Bell shape (substantially paraboloidal shape)

Average arrangement pitch Pm of protrusions: 250 nm

Average height Hm of protrusions: 150 nm

Average aspect ratio (Hm/Pm) of protrusions: 0.6

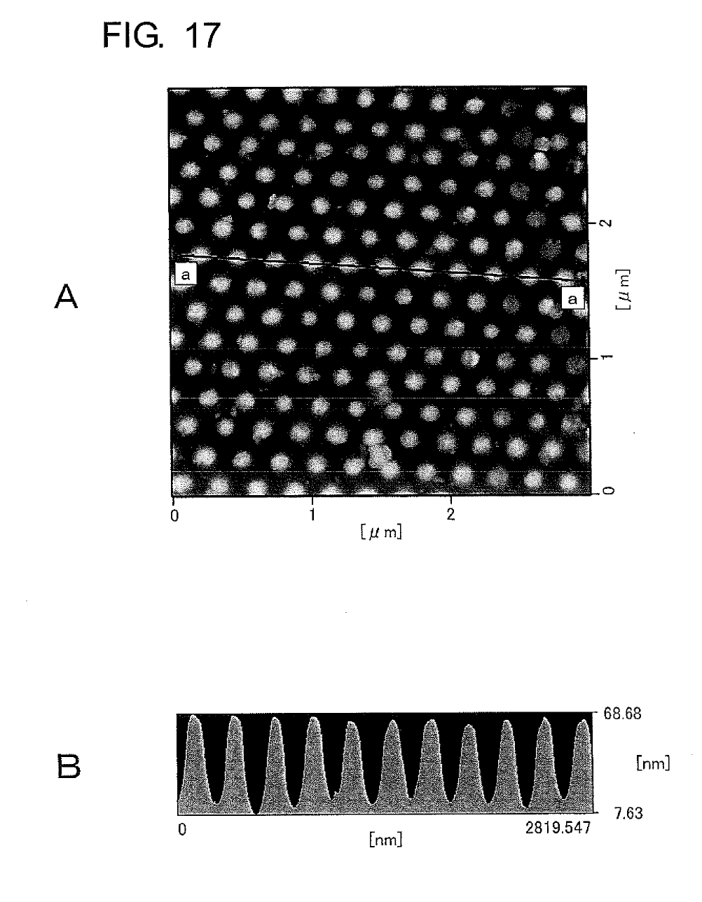

Next, the obtained optical film was cut into a prescribed size. Then a shape transfer surface of the cut optical film was spin-coated with an anti-smudge ultraviolet-curable resin composition (hereinafter referred to as a “UV curable anti-smudge resin”) having a chemical composition described below, and the UV curable anti-smudge resin was dried to thereby form a coating conforming to the plurality of protrusions on the surface of the optical film. Next, the coating was cured by irradiation with ultraviolet rays to form a plurality of protrusions (surface protrusions) having a configuration described below on the surface of the anti-smudge layer. The height and aspect ratio of the protrusions were controlled by the conditions for spin coating with the UV curable anti-smudge resin. The intended anti-smudge film was thereby obtained. FIG. 17A shows an AFM image of the surface of the anti-smudge film in Example 1. FIG. 17B shows a cross-sectional profile along line a-a shown in FIG. 17A.

### (Chemical Composition of UV Curable Anti-Smudge Resin)

Compound having a structure represented by the formula (10) below: 3.5% by mass

Photo-polymerization initiator (product name: IRGACURE-184, manufactured by BASF Japan Ltd.): 0.175% by mass

Cyclohexanone: 96.325% by mass

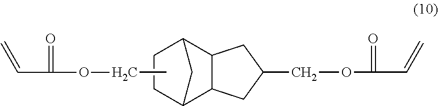

### (Configuration of Protrusions)

Arrangement of protrusions: Closest packed (hexagonal lattice)

Shape of protrusions: Bell shape (substantially paraboloidal shape)

Average arrangement pitch Pm of protrusions: 250 nm

Average height Hm of protrusions: 60 nm

Average aspect ratio (Hm/Pm) of protrusions: 0.24

The intended anti-smudge film was thereby obtained.

### Example 2

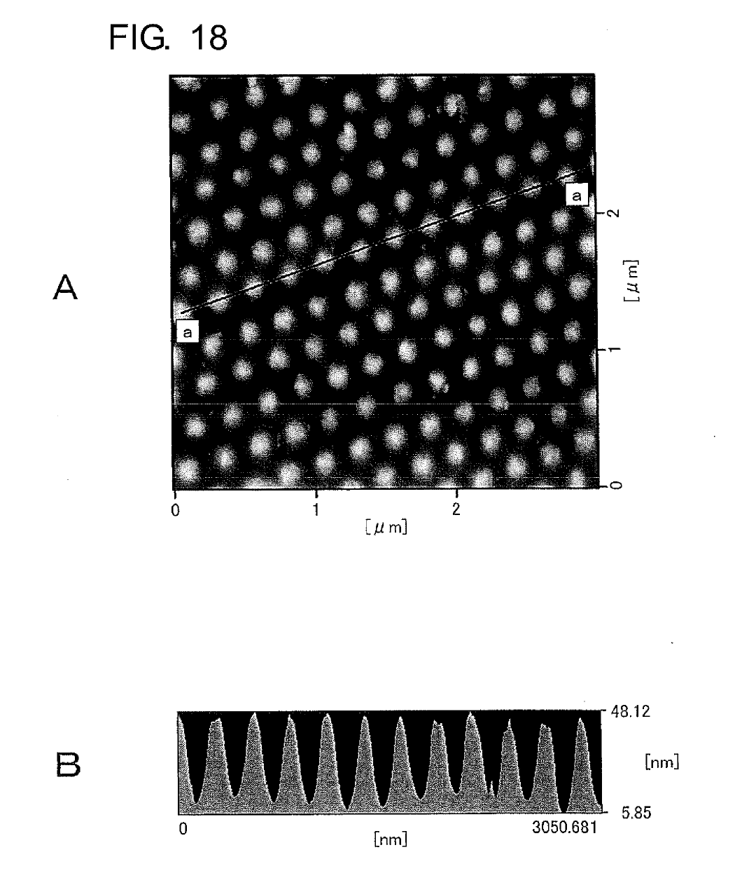

An anti-smudge film was obtained in the same manner as in Example 1 except that the conditions for spin coating with the UV curable anti-smudge resin were adjusted to change the height of the protrusions to 40 nm and their aspect ratio to 0.16. FIG. 18A shows an AFM image of the surface of the anti-smudge film in Example 2. FIG. 18B shows a cross-sectional profile along line a-a shown in FIG. 18A.

### Example 3

An anti-smudge film was obtained in the same manner as in Example 1 except that an ultraviolet-curable resin composition having the following chemical composition was used to form a plurality of protrusions two-dimensionally on the surface of a ZEONOR film.

### (Chemical Composition of Resin Composition)

Urethane acrylate oligomer (product name: CN9006, manufactured by Sartomer): 64% by mass

Polyester acrylate oligomer (product name: CN2302, manufactured by Sartomer): 31% by mass

Photo-polymerization initiator (product name: IRGACURE-184, manufactured by BASF Japan Ltd.): 5% by mass

### Example 4

An anti-smudge film was obtained in the same manner as in Example 1 except that a UV curable anti-smudge resin having the following chemical composition was used.

### (UV Curable Anti-Smudge Resin)

Compound having a structure represented by the formula (11) below: 3.5% by mass

Photo-polymerization initiator (product name: IRGACURE-184, manufactured by BASF Japan Ltd.): 0.175% by mass

Cyclohexanone: 96.325% by mass

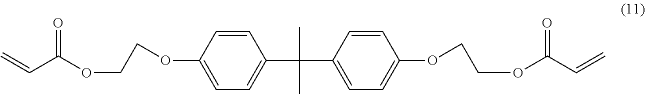 [SMILES: C=CC(=O)OCCOc1ccc(C(C)(C)c2ccc(OCCOC(=O)C=C)cc2)cc1]

### Example 5

An anti-smudge film was obtained in the same manner as in Example 1 except that a UV curable anti-smudge resin having the following chemical composition was used.

### (UV Curable Anti-Smudge Resin)

Compound having a structure represented by the formula (12) below: 3.5% by mass

Photo-polymerization initiator (product name: IRGACURE-184, manufactured by BASF Japan Ltd.): 0.175% by mass

Cyclohexanone: 96.325% by mass

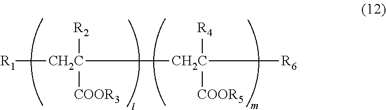

### Example 6

An anti-smudge film was obtained in the same manner as in Example 1 except that a UV curable anti-smudge resin having the following chemical composition was used.

### (UV Curable Anti-Smudge Resin)

Compound having a structure represented by the formula (13) below: 0.3% by mass

Urethane acrylate (product name: CN9006, manufactured by Sartomer): 3.2% by mass

Photo-polymerization initiator (product name: IRGACURE-184, manufactured by BASF Japan Ltd.): 0.175% by mass

Cyclohexanone: 96.325% by mass

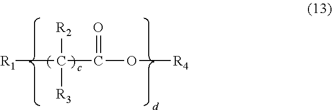

### Example 7

An optical film with a plurality of protrusions formed on its surface was obtained in the same manner as in Example 1. Next, an anti-smudge film was obtained in the same manner as in Example 1 except that an anti-smudge thermosetting resin composition (hereinafter referred to as a “thermosetting anti-smudge resin”) having the following chemical composition was applied to the shape transfer surface of the optical film by spin coating and then heated at 150° C. for 2 hours to heat-cure the thermosetting anti-smudge resin.

(chemical Composition of Thermosetting Anti-Smudge Resin)

Compound having a structure represented by the formula (14) below: 3.5% by mass

Solvent (acetone): 96.5% by mass

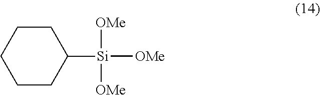 [SMILES: CO[Si](OC)(OC)C1CCCCC1]

### Example 8

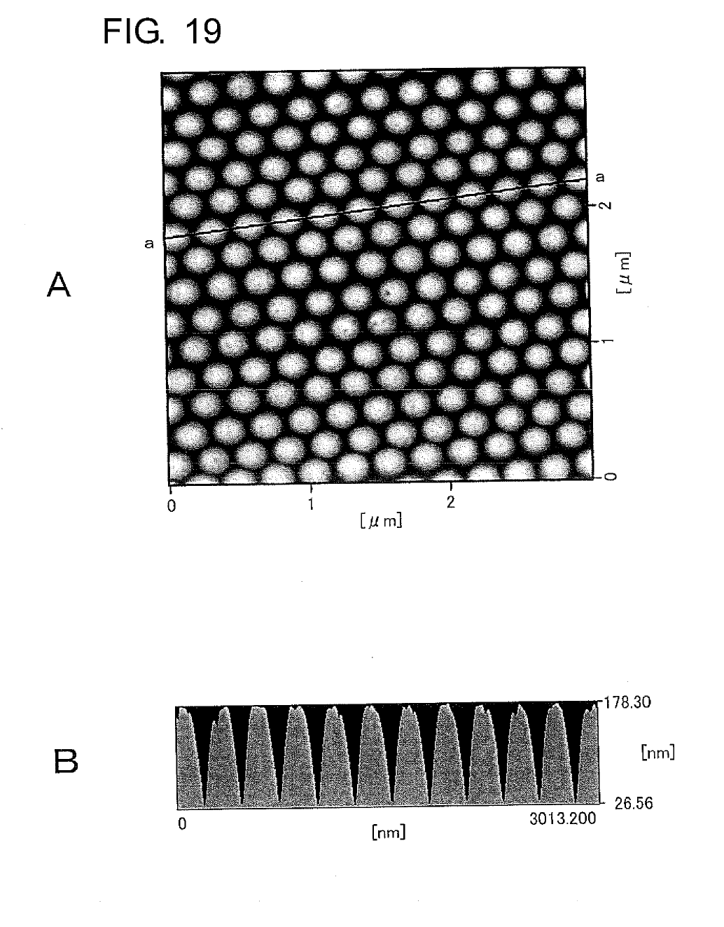

A plurality of protrusions were formed two-dimensionally on the surface of a ZEONOR film in the same manner as in Example 1 except that a UV curable anti-smudge resin having a chemical composition described later was used instead of the UV-curable resin, whereby an anti-smudge film was obtained. In this Example, the plurality of protrusions themselves are formed from the UV curable anti-smudge resin. Since the UV curable anti-smudge resin is applied to the shape transfer surface of the optical film and then cured, the step of forming an anti-smudge layer so as to conform to the surface of the plurality of protrusions is omitted. FIG. 19A shows an AFM image of the surface of the anti-smudge film in Example 8. FIG. 19B shows a cross-sectional profile along line a-a shown in FIG. 19A.

### (Chemical Composition of UV Curable Anti-Smudge Resin)

Compound having a structure represented by the formula (10) below: 95% by mass

Photo-polymerization initiator (product name: IRGACURE-184, manufactured by BASF Japan Ltd.): 5% by mass

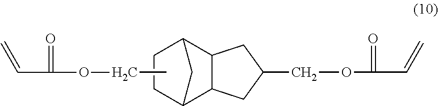

### (Configuration of Protrusions)

Arrangement of protrusions: Closest packed (hexagonal lattice)

Shape of protrusions: Bell shape (substantially paraboloidal shape)

Average arrangement pitch Pm of protrusions: 250 nm

Average height Hm of protrusions: 150 nm

Average aspect ratio (Hm/Pm) of protrusions: 0.6

### Example 9

An anti-smudge film was obtained in the same manner as in Example 1 except that an ultraviolet-curable resin having the following chemical composition was used.

### (UV Curable Anti-Smudge Resin)

Acrylate oligomer having a fluorine atom and a siloxane site: 1.75% by mass

Dipentaerythritol hexaacrylate (DPHA): 1.75% by mass

Photo-polymerization initiator (product name: IRGACURE-184, manufactured by BASF Japan Ltd.): 0.175% by mass

Cyclohexanone: 96.325% by mass

### Comparative Example 1

An anti-smudge film was obtained in the same manner as in Example 1 except that a plurality of protrusions were not formed on the surface of a ZEONOR film and the UV curable anti-smudge resin was applied to the flat surface of the ZEONOR film by spin coating.

### [Evaluation]

The fingerprint resistance (noticeability of fingerprint patterns, wipeability with CLEAN WIPER, and wipeability with a finger) of each of the above-obtained anti-smudge films in Examples 1 to 8 and Comparative Example 1 and their pencil hardness were evaluated.

### (Fingerprint Resistance)

First, an anti-smudge film was bonded to a black acrylic plate (product name: ACRYLITE, manufactured by Mitsubishi Rayon Co., Ltd.) with an evaluation surface (fingerprint resistant surface) of the anti-smudge film facing up using a double-sided adhesive sheet (product name: LUCTACS CS9621T, manufactured by Nitto Denko Corporation). Next, the evaluation surface was smudged with fingerprints, and (a) noticeability of fingerprint patterns, (b) wipeability with CLEAN WIPER, and (c) wipeability with a finger were evaluated according to the following criteria. The results are shown in TABLE 1.

### (a) Noticeability of Fingerprint Patterns

The fingerprint resistant surface was smudged with fingerprints. After one minute, a fluorescent lamp was used to irradiate the evaluation surface. Then the surface was visually observed, and evaluation was made according to the following criteria.

AA: The fingerprint patterns disappeared and became less noticeable.

A: The fingerprint patterns disappeared, but the smudged portions were noticeable.

C: The fingerprint patterns did not disappear.

(b) Wipeability with CLEAN WIPER

The fingerprint resistant surface was smudged intentionally with fingerprints with a liquid amount larger than usual and wiped with KURAFLEX CLEAN WIPER FF-390C such that the CLEAN WIPER was moved so as to draw a circle 10 times. Then a fluorescent lamp was used to irradiate the fingerprint resistant surface. Then the surface was visually observed, and evaluation was made according to the following criteria.

AA: No oily smudges remained.

A: A slight amount of oily smudges remained.

C: A large amount of oily smudges remained.

(c) Wipeability with Finger

The fingerprint resistant surface was smudged intentionally with fingerprints with a liquid amount larger than usual and wiped back and forth 10 times with a finger. Then a fluorescent lamp was used to irradiate the fingerprint resistant surface. Then the surface was visually observed, and evaluation was made according to the following criteria.

AA: No oily smudges remained.

A: A slight amount of oily smudges remained.

C: A large amount of oily smudges remained.

### (Pencil Hardness)

The pencil hardness was evaluated according to JIS K5600 5-4.

TABLE 1 shows the configuration of each of the anti-smudge films in Examples 1 to 9 and Comparative Example 1 and the results of the evaluation.

TABLE 1

| | | Irregular Shape of Transferred Objects | | | | Noticeability | Wipeability | | |
|---|---|---|---|---|---|---|---|---|---|
| | | | Pm | Hm | | of Fingerprint | with Clean | Wipeability | Pencil |
| | Material of Anti-Smudge Layer | Structure | (nm) | (nm) | Asp. | Patterns | Wiper | with Finger | Hardness |
| Example 1 | Second Compound | Closest Packed | 250 | 60 | 0.24 | AA | AA | AA | — |
| | (Cyclic Hydrocarbon Group) | | | | | | | | |
| Example 2 | Second Compound | Closest Packed | 250 | 40 | 0.16 | AA | AA | AA | — |
| | (Cyclic Hydrocarbon Group) | | | | | | | | |
| Example 3 | Second Compound | Closest Packed | 250 | 60 | 0.24 | AA | AA | AA | 2H |
| | (Cyclic Hydrocarbon Group) | | | | | | | | |
| Example 4 | Second Compound | Closest Packed | 250 | 60 | 0.24 | AA | AA | AA | — |
| | (Cyclic Hydrocarbon Group) | | | | | | | | |
| Example 5 | First Compound | Closest Packed | 250 | 60 | 0.24 | AA | AA | AA | — |
| | (Ester Linkage in Portion Other | | | | | | | | |
| | Than Terminal Ends) | | | | | | | | |
| Example 6 | First Compound | Closest Packed | 250 | 60 | 0.24 | AA | AA | AA | — |
| | (Ester Linkage in Portion Other | | | | | | | | |
| | Than Terminal Ends) | | | | | | | | |
| Example 7 | Second Compound | Closest Packed | 250 | 60 | 0.24 | AA | AA | AA | — |
| | (Cyclic Hydrocarbon Group) | | | | | | | | |
| Example 8 | Second Compound | Closest Packed | 250 | 150 | 0.6 | A | C | C | — |
| | (Cyclic Hydrocarbon Group) | | | | | | | | |
| Example 9 | First Compound | Closest Packed | 250 | 60 | 0.24 | AA | AA | AA | — |
| | (Ester Linkage in Portion Other | | | | | | | | |
| | Than Terminal Ends) | | | | | | | | |
| Comparative | Second Compound | — | — | — | — | C | A | A | — |
| Example 1 | (Cyclic Hydrocarbon Group) | | | | | | | | |

Pm: Average Arrangement Pitch of Protrusions
Hm: Average Height of Protrusions
Asp.: Average Aspect Ratio of Protrusions (Hm/Pm)

The following can be seen from TABLE 1.

Example 1: Since the anti-smudge layer contains the second compound having a cyclic hydrocarbon group and the plurality of protrusions with an average height Hm of 60 nm are disposed on the fingerprint resistant surface, noticeability of fingerprint patterns can be reduced, and high wipeability can be obtained.

Example 2: Even when the average height Hm of the plurality of protrusions on the fingerprint resistant surface is 40 nm, noticeability of fingerprint patterns can be reduced, and high wipeability can be obtained.

Example 3: By adjusting the chemical composition of the UV curable resin composition, a hard coating function can be further imparted to the fingerprint resistant surface, in addition to the above-described effects in Examples 1 and 2.

Example 4: Although the anti-smudge layer contains a second compound different from that in Example 1, the same effects as in Example 1 are obtained.

Example 5: Since the anti-smudge layer contains a first compound having an ester linkage in a portion other than its terminal ends and a plurality of protrusions with an average height Hm of 60 nm are disposed on the fingerprint resistant surface, noticeability of fingerprint patterns can be reduced, and high wipeability can be obtained, as in Example 1.

Example 6: Although the anti-smudge layer contains a first compound different from that in Example 5, the same effects as in Example 5 are obtained.

Example 7: Even when a thermosetting anti-smudge resin containing a second compound is used, noticeability of fingerprint patterns can be reduced, and high wipeability can be obtained, as in the case where a UV curable anti-smudge resin containing the second compound is used (Example 1).

Example 8: Since the plurality of protrusions contain the second compound having a cyclic hydrocarbon group and the plurality of protrusions with an average height Hm of 150 nm are disposed on the fingerprint resistant surface, noticeability of fingerprint patterns can be reduced, but wipeability deteriorates.

Example 9: Although the anti-smudge layer contains a first compound different from that in Example 5, the same effects as in Example 5 are obtained.

Comparative Example 1: No protrusions are provided on the surface of the substrate, and the anti-smudge layer is provided directly on the surface of the substrate. Although high wipeability can be obtained, noticeability of fingerprint patterns cannot be reduced.

In comprehensive consideration of the above, when the anti-smudge layer contains at least one of the first compound and the second compound and a plurality of protrusions are disposed on the fingerprint resistant surface, noticeability of fingerprint patterns can be reduced.

To reduce the noticeability of fingerprint patterns and to obtain high wipeability, it is preferable that at least one of the first compound and the second compound be contained in the anti-smudge layer and a plurality of protrusions with an average height Hm of 100 nm or smaller and preferably 60 nm or smaller be provided on the fingerprint resistant surface.

The embodiments of the present technique have been specifically described above. However, the present technique is not limited to the above embodiments, and various modifications can be made on the basis of the technical idea of the present technique.

For example, the configurations, methods, processes, shapes, materials, values, etc. described in the above embodiments are merely examples, and configurations, methods, processes, shapes, materials, values, etc. different from those described above may be used as needed.

The configurations, methods, processes, shapes, materials, values, etc. in the above embodiments may be mutually combined so long as the combination does not depart from the gist of the present technique.

In addition, the present technique may be configured as follows.
(1) An anti-smudge body having

a surface and a plurality of protrusions provided thereto, wherein

the protrusions contain at least one of a first compound having an ester linkage in a portion other than terminal ends and a second compound having a cyclic hydrocarbon group.
(2) The anti-smudge body according to (1), wherein an average height of the protrusions is in a range of 10 nm or larger and 150 nm or smaller, and

an average pitch of the protrusions is in a range of 100 nm or larger and 500 nm or smaller.
(3) The anti-smudge body according to (2), wherein the average height of the protrusions is in a range of 10 nm or larger and 100 nm or smaller.
(4) The anti-smudge body according to any of (1) to (3), including

a substrate having a surface, and

an anti-smudge layer provided on the surface of the substrate, wherein

the anti-smudge layer has a surface on which the plurality of protrusions are disposed.
(5) The anti-smudge body according to (4), wherein

the anti-smudge layer contains at least one resin composition of an energy ray-curable resin composition and a thermosetting resin composition, and

the resin composition contains the at least one of the first compound and the second compound.
(6) The anti-smudge body according to any of (1) to (5), wherein the first compound and the second compound are each an additive.
(7) The anti-smudge body according to (6), wherein the additive is a leveling agent.
(8) The anti-smudge body according to any of (4) to (7), wherein a plurality of protrusions are disposed on the surface of the substrate, and

the anti-smudge layer is provided so as to conform to the surface of the plurality of protrusions of the substrate.
(9) The anti-smudge body according to (8), wherein the at least one of the first compound and the second compound is adsorbed onto the surface of the plurality of protrusions of the substrate.
(10) The anti-smudge body according to (9), wherein the anti-smudge layer is a monomolecular layer containing the at least one of the first compound and the second compound.
(11) The anti-smudge body according to any of (1) to (3), wherein

the protrusions contain a thermoplastic resin composition, and

the thermoplastic resin composition contains the at least one of the first compound and the second compound. (12) The anti-smudge body according to any of (1) to (11), wherein

the first compound is represented by the formula (1) or (2) below, and

the second compound is represented by the formula (3) or (4) below,

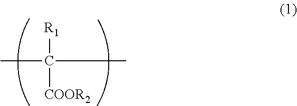

wherein, in the formula (1), R₁ is a group containing C, N, S, O, Si, P, or Ti, and R₂ is a group having 2 or more carbon atoms,

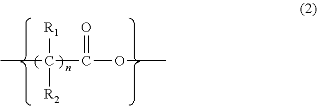

wherein, in the formula (2), R₁ and R₂ are each independently a group containing C, N, S, O, Si, P, or Ti

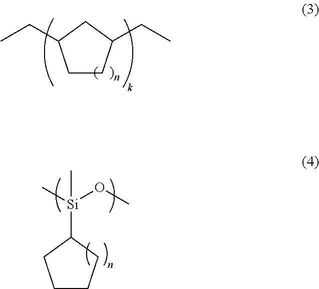

(13) The anti-smudge body according to (12), wherein R₁ and R₂ in the formulas (1) and (2) above are each independently a hydrocarbon group, a sulfo group, a sulfonyl group, a sulfonamide group, a carboxylic acid group, an amino group, an amide group, a phosphoric acid group, a phosphino group, a silanol group, an epoxy group, an isocyanate group, a cyano group, a thiol group, or a hydroxyl group.
(14) The anti-smudge body according to any of (1) to (13), wherein the anti-smudge layer further contains, together with the second compound, a third compound having a chain hydrocarbon group at a terminal end.
(15) The anti-smudge body according to (14), wherein the third compound is represented by the formula (5) or (6) below

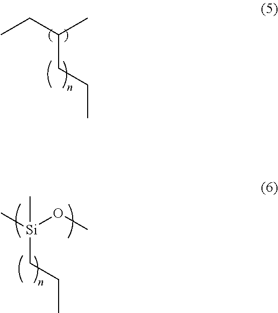

(16) The anti-smudge body according to any of (1) to (15), wherein the plurality of protrusions are arranged two-dimensionally.
(17) The anti-smudge body according to any of (1) to (16), wherein a recessed portion between the protrusions causes positive capillary pressure to act on a liquid present on the surface.
(18) An input device having

an input surface and a plurality of protrusions provided thereto, wherein

the protrusions contain at least one of a first compound having an ester linkage in a portion other than terminal ends and a second compound having a cyclic hydrocarbon group.
(19) A display device having

a display surface and a plurality of protrusions provided thereto, wherein

the protrusions contain at least one of a first compound having an ester linkage in a portion other than terminal ends and a second compound having a cyclic hydrocarbon group.
(20) An electronic device having

a surface and a plurality of protrusions provided thereto, wherein

the protrusions contain at least one of a first compound having an ester linkage in a portion other than terminal ends and a second compound having a cyclic hydrocarbon group.
(21) An anti-smudge article having

a surface and a plurality of protrusions provided thereto, wherein

the protrusions contain at least one of a first compound having an ester linkage in a portion other than terminal ends and a second compound having a cyclic hydrocarbon group.
(22) An anti-smudge body having an anti-smudge surface and a plurality of protrusions provided thereto.

### REFERENCE SIGNS LIST

11, 21 substrate

12, 25 anti-smudge layer

12a, 22 protrusion

12b, 24b base layer

13 anchor layer

14 hard coating layer

15 transparent conductive layer

23 anti-smudge structure layer

23a surface protrusion (first protrusion)

24 fine structure layer

24a inner protrusion (second protrusion)

25a adsorption compound

31 master roll

32 structure body

101, 113, 125, 133, 143 display device

102 input device

103 front panel

111 television set

112, 124, 132, 142 casing

121 notebook-type personal computer

131 cellular phone

141 tablet-type computer

S fingerprint resistant surface (anti-smudge surface)

S₁ display surface

S₂ input surface

1. An anti-smudge body comprising
a surface and a plurality of protrusions provided thereto, wherein
the protrusions contain at least one of a first compound having an ester linkage in a portion other than terminal ends and a second compound having a cyclic hydrocarbon group.

2. The anti-smudge body according to claim 1, wherein an average height of the protrusions is in a range of 10 nm or larger and 150 nm or smaller, and
an average pitch of the protrusions is in a range of 100 nm or larger and 500 nm or smaller.

3. The anti-smudge body according to claim 2, wherein the average height of the protrusions is in a range of 10 nm or larger and 100 nm or smaller.

4. The anti-smudge body according to claim 1, comprising
a substrate having a surface, and
an anti-smudge layer provided on the surface of the substrate, wherein
the anti-smudge layer has a surface on which the plurality of protrusions are disposed.

5. The anti-smudge body according to claim 4, wherein
the anti-smudge layer contains at least one resin composition of an energy ray-curable resin composition and a thermosetting resin composition, and
the resin composition contains the at least one of the first compound and the second compound.

6. The anti-smudge body according to claim 1, wherein the first compound and the second compound are each an additive.

7. The anti-smudge body according to claim 6, wherein the additive is a leveling agent.

8. The anti-smudge body according to claim 4, wherein a plurality of protrusions are disposed on the surface of the substrate, and
the anti-smudge layer is provided so as to conform to the surface of the plurality of protrusions of the substrate.

9. The anti-smudge body according to claim 8, wherein the at least one of the first compound and the second compound is adsorbed onto the surface of the plurality of protrusions of the substrate.

10. The anti-smudge body according to claim 9, wherein the anti-smudge layer is a monomolecular layer containing the at least one of the first compound and the second compound.

11. The anti-smudge body according to claim 1, wherein
the protrusions contain a thermoplastic resin composition, and
the thermoplastic resin composition contains the at least one of the first compound and the second compound.

12. The anti-smudge body according to claim 1, wherein
the first compound is represented by the formula (1) or (2) below, and
the second compound is represented by the formula (3) or (4) below, 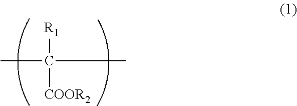
(wherein, in the formula (1), R₁ is a group containing C, N, S, O, Si, P, or Ti, and R₂ is a group having 2 or more carbon atoms), 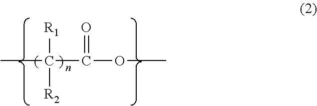
(wherein, in the formula (2), R₁ and R₂ are each independently a group containing C, N, S, O, Si, P, or Ti)

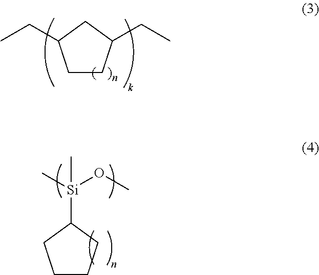

13. The anti-smudge body according to claim 12, wherein R₁ and R₂ in the formulas (1) and (2) above are each independently a hydrocarbon group, a sulfo group, a sulfonyl group, a sulfonamide group, a carboxylic acid group, an amino group, an amide group, a phosphoric acid group, a phosphino group, a silanol group, an epoxy group, an isocyanate group, a cyano group, a thiol group, or a hydroxyl group.

14. The anti-smudge body according to claim 1, wherein the anti-smudge layer further contains, together with the second compound, a third compound having a chain hydrocarbon group at a terminal end.

15. The anti-smudge body according to claim 14, wherein the third compound is represented by the formula (5) or (6) below

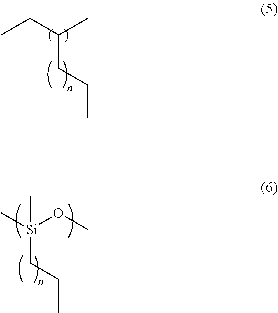

16. The anti-smudge body according to claim 1, wherein the plurality of protrusions are arranged two-dimensionally.

17. The anti-smudge body according to claim 1, wherein a recessed portion between the protrusions causes positive capillary pressure to act on a liquid present on the surface.

18. An input device comprising
an input surface and a plurality of protrusions provided thereto, wherein
the protrusions contain at least one of a first compound having an ester linkage in a portion other than terminal ends and a second compound having a cyclic hydrocarbon group.

19. A display device comprising
a display surface and a plurality of protrusions provided thereto, wherein
the protrusions contain at least one of a first compound having an ester linkage in a portion other than terminal ends and a second compound having a cyclic hydrocarbon group.

20. An electronic device comprising
a surface and a plurality of protrusions provided thereto, wherein
the protrusions contain at least one of a first compound having an ester linkage in a portion other than terminal ends and a second compound having a cyclic hydrocarbon group.

21. An anti-smudge article comprising
a surface and a plurality of protrusions provided thereto, wherein
the protrusions contain at least one of a first compound having an ester linkage in a portion other than terminal ends and a second compound having a cyclic hydrocarbon group.

22. An anti-smudge body comprising an anti-smudge surface and a plurality of protrusions provided thereto.
